(19) United States
(12) Patent Application Publication
(10) Pub. No.: US 2024/0028330 A1
(43) Pub. Date: Jan. 25, 2024

(54) METHODS AND SUBSYSTEMS THAT MANAGE CODE CHANGES SUBMITTED FOR PROCESSING BY AN AUTOMATED APPLICATION-DEVELOPMENT-AND-RELEASE-MANAGEMENT SYSTEM

(71) Applicant: VMware, Inc., Palo Alto, CA (US)

(72) Inventors: Yang Yang, Shanghai (CN); Yang Yang, Shanghai (CN); Sixuan Yang, Shanghai (CN); Jin Feng, Shanghai (CN); Chengmao Lu, Shanghai (CN); Zhou Huang, Shanghai (CN); Junchi Zhang, Palo Alto, CA (US)

(73) Assignee: VMware, Inc., Palo Alto, CA (US)

(21) Appl. No.: 17/891,019

(22) Filed: Aug. 18, 2022

(30) Foreign Application Priority Data
Jul. 20, 2022 (WO) PCT/CN2022/106716

(51) Int. Cl. G06F 8/77; G06F 8/60; G06F 8/41

(52) U.S. Cl. CPC G06F 8/77; G06F 8/60; G06F 8/447

(57) ABSTRACT

The current document is directed to methods and subsystems that manage submitted code changes for processing by continuous-integration/continuous-delivery/deployment systems. In disclosed implementations, code changes are processed as quickly as possible, when the code changes are flagged as being urgent. Non-urgent code changes are evaluated for the possibility of merging the non-urgent code changes with additional, subsequently submitted code changes in order to more efficiently employ computational resources needed for processing the code changes. When there is a code change, waiting for processing, with which a submitted code change can be merged, the submitted code change is merged with the waiting code change so that the merged code changes can be together verified. Otherwise, a submitted code change that has been evaluated to have a reasonable possibility of being merged with subsequently submitted code changes is placed in a queue for processing, where the submitted code change waits for submission of one or more additional code changes that can be merged with the submitted code change.

### TECHNICAL FIELD

The current document is directed to continuous development and deployment of distributed applications in distributed computer systems and, in particular, to methods and subsystems that manage submitted code changes for processing by an automated application-development-and-release-management system.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. Distributed computer systems have, in turn, provided the platform for many new types of distributed functionalities and services, including continuous-integration/continuous-delivery/deployment systems and services that allow for rapid updates to distributed applications, automated testing and verification of the updated distributed applications, and automated delivery and deployment of updated distributed applications to distributed computer systems. The management of code updates for processing by continuous-integration/continuous-delivery/deployment systems and services is associated with a variety of different trade-offs and that affects the efficiencies of application developers who use continuous-integration/continuous-delivery deployment systems and services as well as the computational efficiencies of continuous-integration/continuous-delivery/deployment systems.

### SUMMARY

The current document is directed to methods and subsystems that manage submitted code changes for processing by an automated application-development-and-release-management system. In disclosed implementations, code changes are processed as quickly as possible, when the code changes are flagged as being urgent. Non-urgent code changes are evaluated for the possibility of merging the non-urgent code changes with additional, subsequently submitted code changes in order to more efficiently employ computational resources needed for processing the code changes. When there is a code change, waiting for processing, with which a submitted code change can be merged, the submitted code change is merged with the waiting code change so that the merged code changes can be together verified. Otherwise, a submitted code change that has been evaluated to have a reasonable possibility of being merged with subsequently submitted code changes is placed in a queue for processing, where the submitted code change waits for submission of one or more additional code changes that can be merged with the submitted code change.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a virtual-data-center management server and physical servers of a physical data center above which a virtual-data-center interface is provided by the virtual-data-center management server.

FIG. 9 illustrates a cloud-director level of abstraction. In FIG. 9, three different physical data centers 902-904 are shown below planes representing the cloud-director layer of abstraction 906-908.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates an automated application-development-and-release-management system that includes continuous-integration and continuous-delivery/deployment functionalities.

FIG. 12 shows a graph, often referred to as a “topological graph,” that describes the mapping from source-code files through intermediate executables to target distributed-application executables.

FIGS. 13A-B illustrate processing of source-code changes by the continuous-integration and continuous-delivery/deployment functionalities of the automated application-development-and-release-management system.

FIGS. 14A-D illustrate processing of two source-code changes by the continuous-integration and continuous-delivery/deployment functionalities of the automated application-development-and-release-management system, using the same illustration conventions as used in FIGS. 13A-B.

FIG. 15 illustrates a general mechanism for input of submitted code changes to the continuous-delivery/deployment functionalities of the automated application-development-and-release-management system.

FIG. 16 illustrates implementation of a circular queue from a linear buffer.

FIGS. 17A-D illustrate various trade-offs involved in different approaches to managing submitted code changes.

FIGS. 18A-B illustrate data structures used in control-flow diagrams discussed with reference to FIGS. 19A-F and 21-25, which illustrate one implementation of the currently disclosed methods and subsystems.

FIGS. 19A-F provide control-flow diagrams that illustrate one implementation of a method for determining the relevance of two code changes, carried out by the currently disclosed methods and subsystems in order to determine whether or not to merge code changes into an aggregate code change.

FIG. 20 illustrates data structures used in one implementation of the currently disclosed methods and subsystems discussed below with reference to FIGS. 21-25.

FIG. 21 provides a control-flow diagram for the routine “code checkin,” which is a continuously looping asynchronous process that receives code-change requests and manages the received code-change requests up until they are submitted to the continuous-delivery/deployment functionalities of the automated application-development-and-release-management system for processing.

FIGS. 22A-C provide control-flow diagrams for the routine “new code change,” called in step 2108 of FIG. 21.

FIGS. 23A-B provide control-flow diagrams for the routine “maintenance timer,” called in step 2112 of FIG. 21.

FIGS. 24A-B provide control-flow diagrams for the routine “queueCodeChecks,” called in step 2328 of FIG. 23B.

FIG. 25 provides a control-flow diagram for the routine “exQ available,” called in step 2116 of FIG. 21.

### DETAILED DESCRIPTION

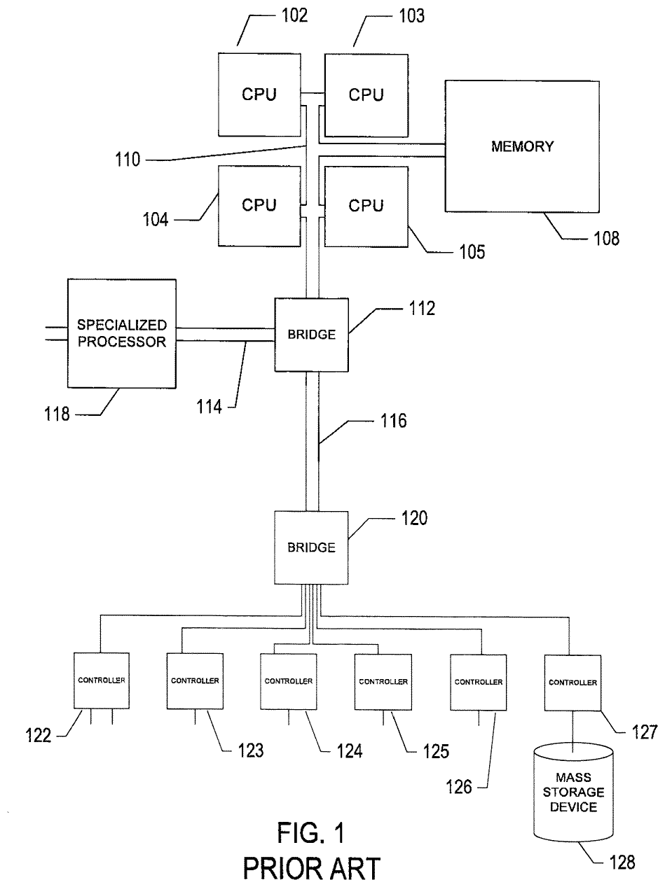

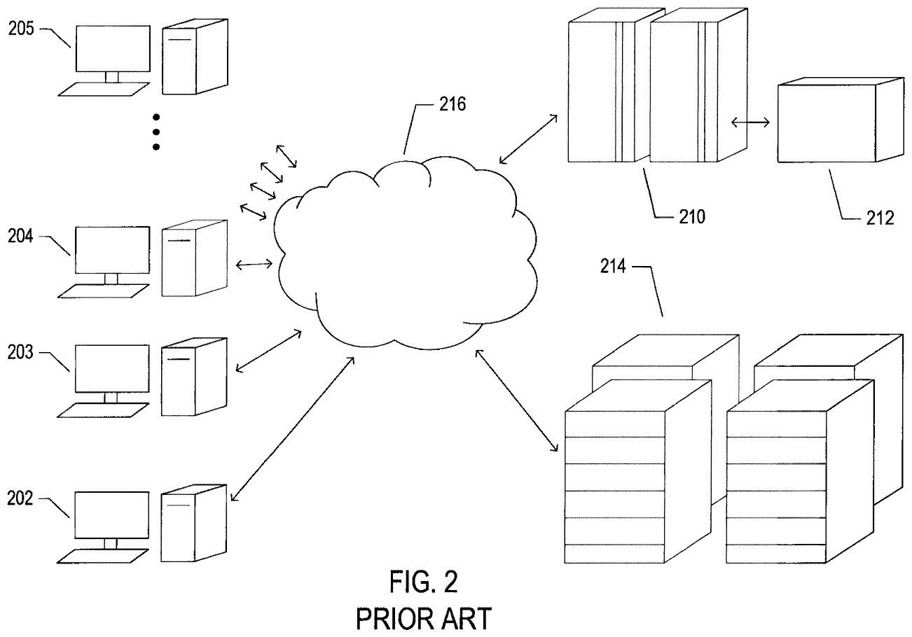

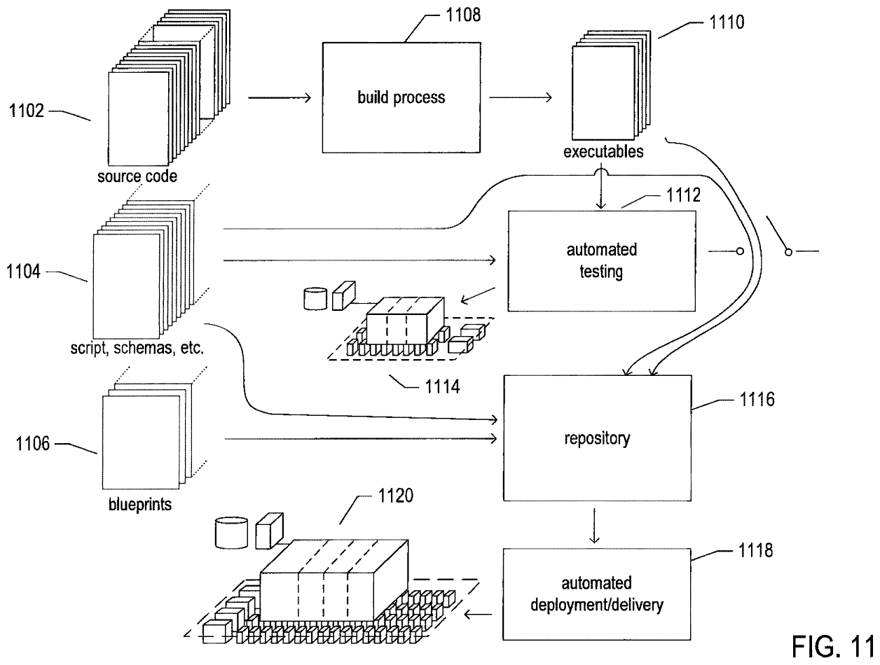

The current document is directed to methods and subsystems that manage submitted code changes for processing by an automated application-development-and-release-management system. In a first subsection, below, a detailed description of computer hardware, complex computational systems, and virtualization is provided with reference to FIGS. 1-11. In a second subsection, the currently disclosed methods and systems are discussed with reference to FIGS. 11-25.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software.” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

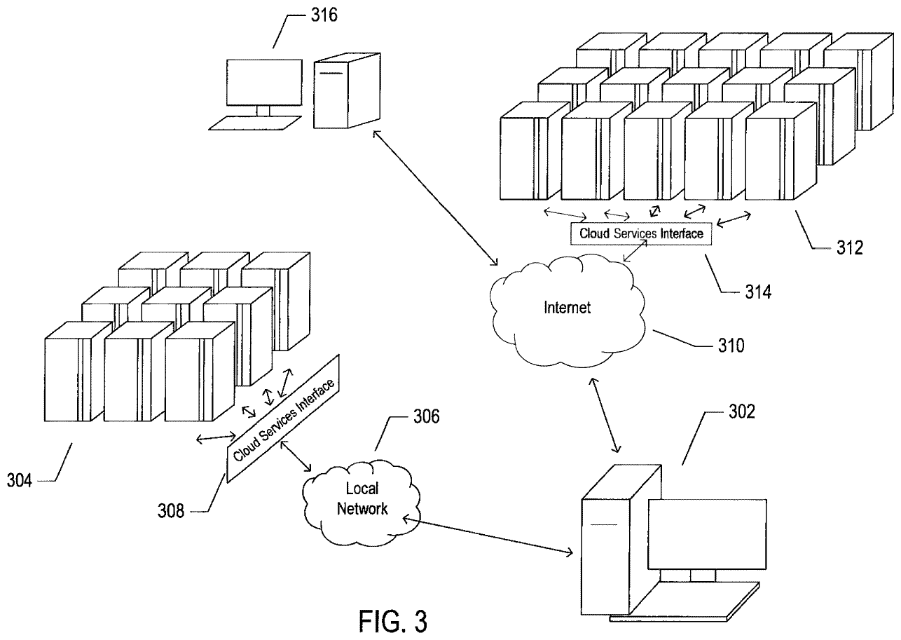

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

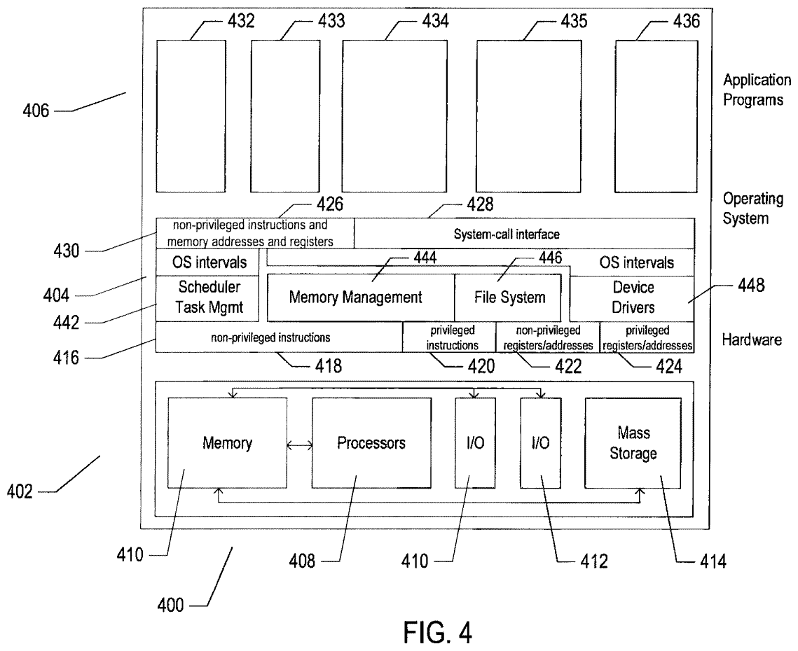

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

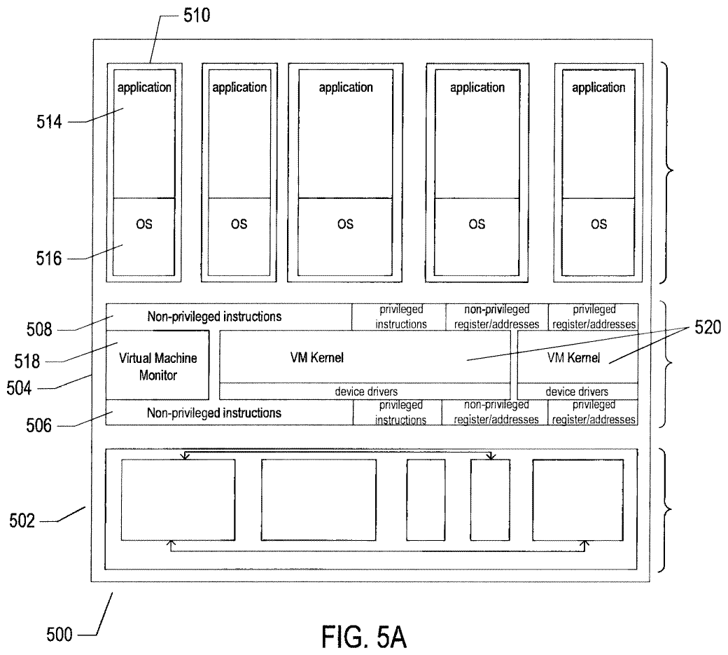

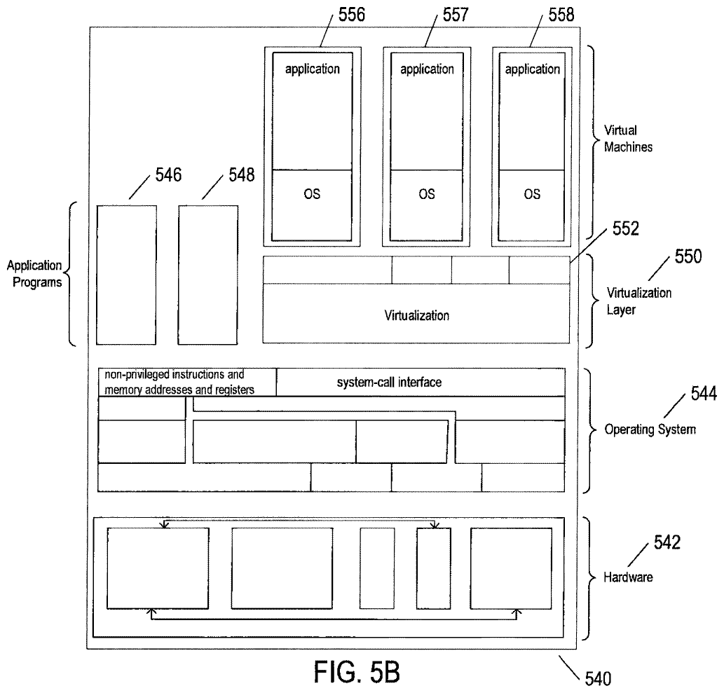

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

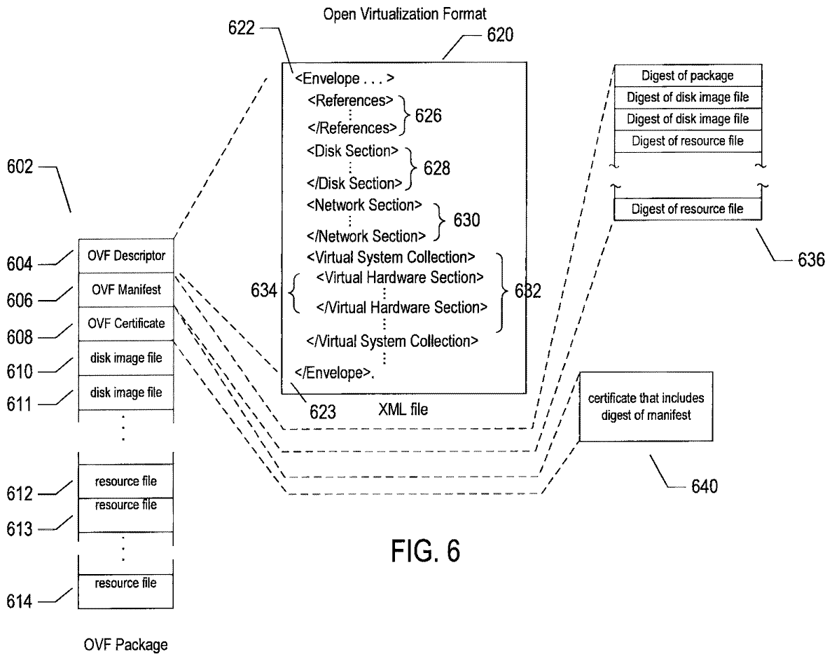

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

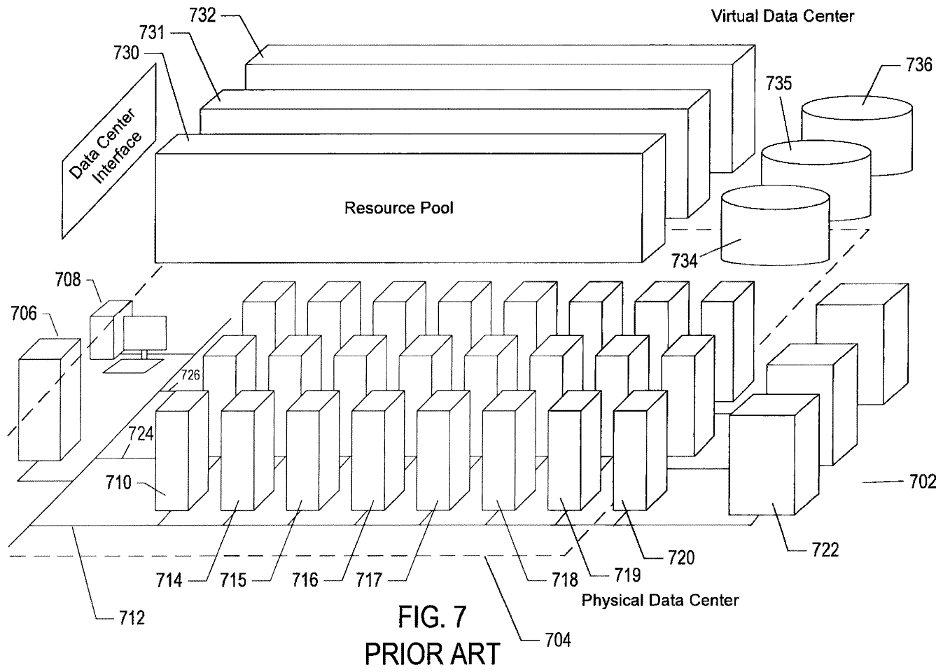

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers or virtual infrastructure, provides a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

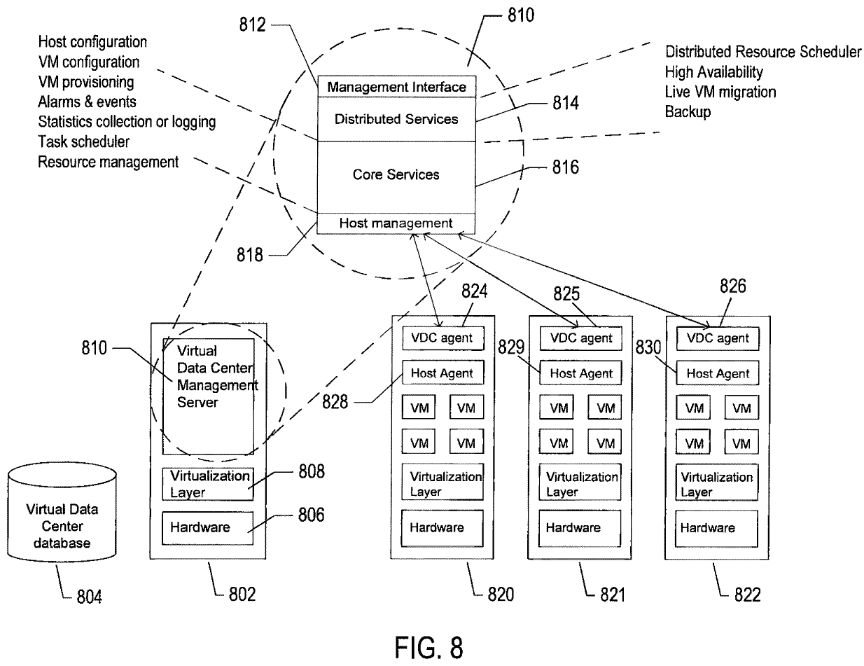

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the virtual-data-center management server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability. FIG. 8 illustrates virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server virtual machine 810 above the virtualization layer. Although shown as a single server in FIG. 8, the virtual-data-center management server (“VDC management server”) may include two or more physical server computers that support multiple VDC-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VDC management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VDC management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VDC management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

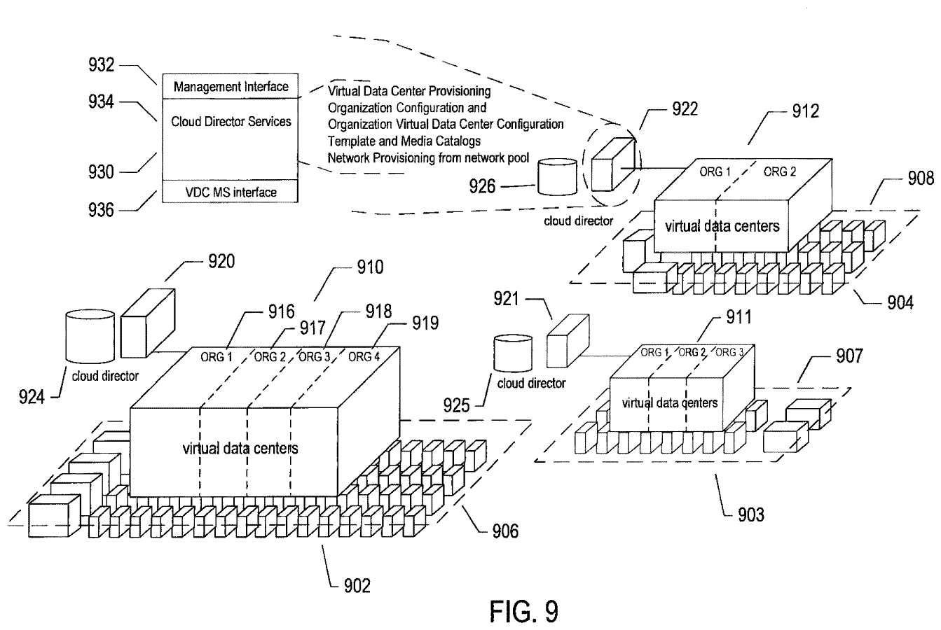

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

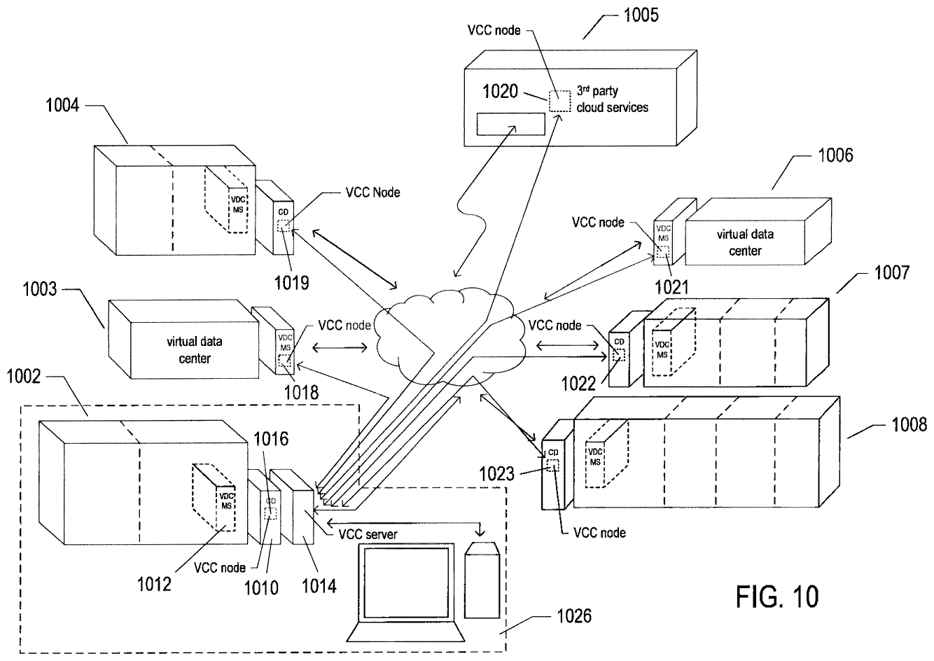

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Currently Disclosed Methods and Systems

FIG. 11 illustrates an automated application-development-and-release-management system that includes continuous-integration and continuous-delivery/deployment functionalities. A distributed application may be defined by information contained in a variety of different electronic files, including source-code files 1102, scripts, database schemas, and other types of higher-level specifications stored in various different types of files 1104, and application blueprints 1106 that specify the required computational resources for supporting the distributed application and a mapping of distributed-application-executable instances to computational resources provided by a distributed computer system, including virtual machines, virtual networks, virtual storage appliances, and/or server computers, local-area and wide-area networks, data-storage appliances. Source code is compiled and linked by a build process 1108 in order to produce executables 1110, including intermediate executables and various different types of distributed-application instances referred to as “target executables.” The distributed-application instances are then automatically tested by automated testing-and-verification components 1112 of the automated application-development-and-release-management system. The testing is generally carried out on the distributed computer system 1114 that supports execution of the automated application-development-and-release-management system or on another distributed computer system, such as a private data center or a virtual data center implemented by a cloud-computing facility. Once the distributed-application instances have been tested and verified, they are stored in a repository component 116 of the automated application-development-and-release-management system from which they are retrieved and used by automated-deployment and automated-delivery components 118 of the automated application-development-and-release-management system to deploy the distributed application to distributed computer systems 1120, including data centers and virtual data centers managed by client organizations, cloud-computing facilities that provide computational resources to client organizations, and other computational environments. An automated application-development-and-release-management system may itself be a component of a distributed-computer-system or cloud-computing-facility management system.

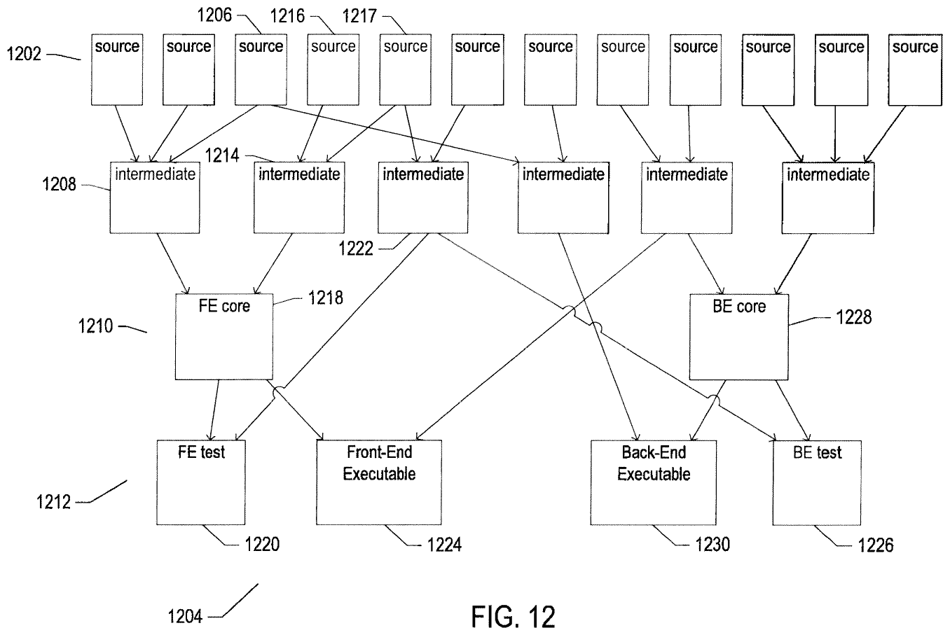

FIG. 12 shows a graph, often referred to as a “topological graph,” that describes the mapping from source-code files through intermediate executables to target distributed-application executables. The graph shown in FIG. 12 is a very small example, for illustration purposes. The graph for a real-world distributed application may include many hundreds or thousands of source-code files, intermediate executables, and target executables. The first, top layer 1202 in the graph 1204 includes nodes representing search-code files, such as node 1206 representing a source-code file. The example graph shown in FIG. 12 includes two layers 1208 and 1210 of nodes representing intermediate executables and a final layer 1212 of nodes representing target executables. Intermediate and target executables are also generally stored in files, as is source code. In this example, various combinations of source-code files are used to generate each of the first-layer intermediate executables. For example, first-layer intermediate executable 1214 is generated by compiling and linking source-code files 1216-1217. Various combinations of the first-layer intermediate executables are combined to generate the second-layer executables. For example, first-layer intermediate executables 1208 and 1214 are combined to generate the second-layer intermediate executable “FE core” 1218. Finally, combinations of first-layer and the second-layer executables are used to produce each of the target executables in the final, target layer 1212. For example, the target executable “FE test” 1220 is produced by combining second-layer intermediate executable 1218 and first-layer intermediate executable 1222. The target executable “FE test” is a test executable for testing the “FE core executable” 1218 and the target executable “Front-End Executable” 1224 is a distributed-application executable used for front-end instances of the distributed application. Similarly, the target executable “BE test” 1226 is a test executable for the “BE core” intermediate executable 1228 and the target executable “Back-End Executable” 1230 is a distributed-application executable used for back- and instances of the distributed application. Thus, the graph consists of discrete layers of nodes, each node of each layer corresponding to one of a source-code file, an intermediate executable, and a target executable. Although the first-layer intermediate executables are all generated from source-code-layer source-code files in the example shown in FIG. 12, it is generally the case that intermediate-layer and target-layer nodes may be direct children of parent nodes within two or more higher layers of the graph. In addition, various other of the higher-level entities (1104 in FIG. 11) may be used in generating executables or associated with executables.

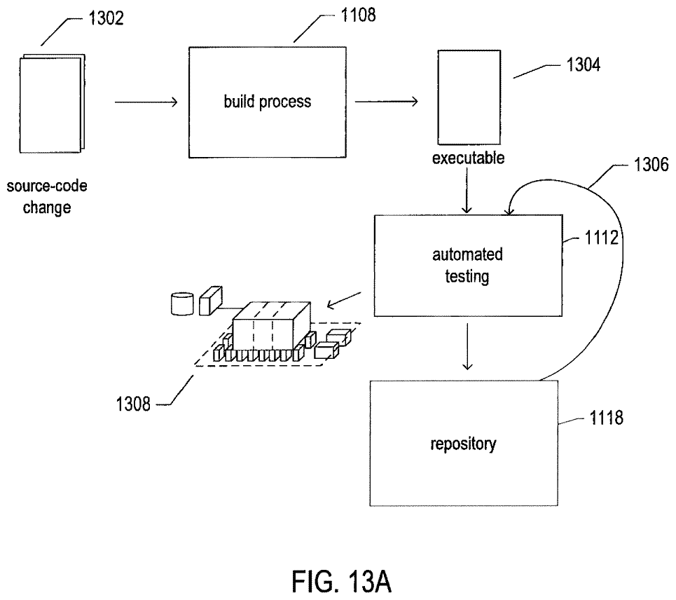

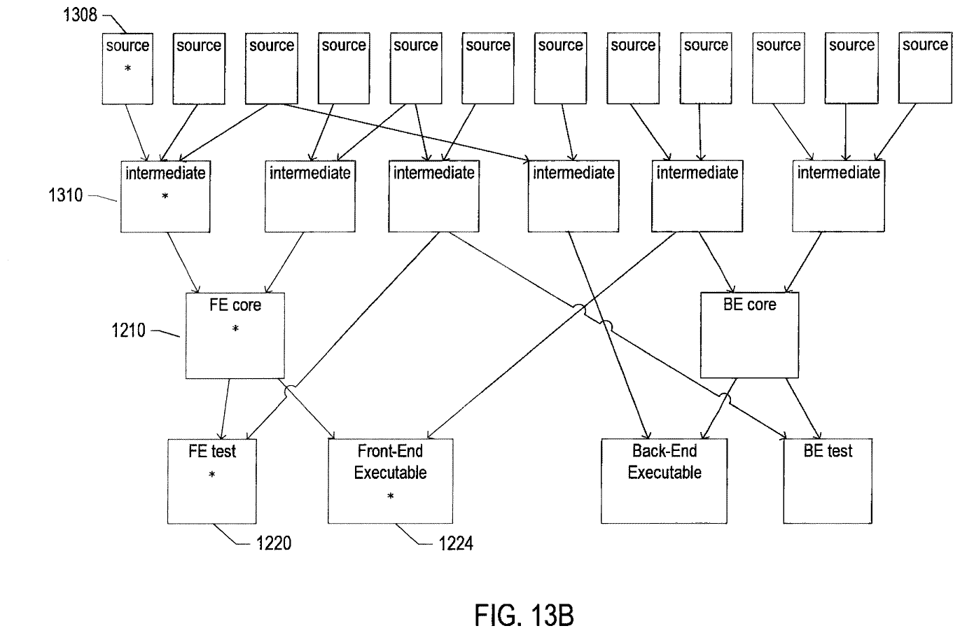

FIGS. 13A-B illustrate processing of source-code changes by the continuous-integration and continuous-delivery/deployment functionalities of the automated application-development-and-release-management system. In the example illustrated in FIGS. 13A-B, a source-code change to a particular source-code file 1302 is submitted to the continuous-integration and continuous-delivery/deployment functionalities of the automated application-development-and-release-management system. The build-process component 1108 of the automated application-development-and-release-management system generates one or more executables 1304 that are impacted by the source-code change, which are then submitted for automated testing and verification to the testing-and-verification components 1112 of the automated application-development-and-release-management system. Once tested and verified, the executables 1304 are then stored in the depository for subsequent use in delivery and deployment of the distributed application. Curved arrow 1306 indicates that stored executables may be used, in addition to the executables 1304 generated by the build process 1108, to produce executables for running within a test system 1308 for testing and verifying the code changes.

FIG. 13B illustrates the impact of the source-code change 1302 on the source-code files, intermediate executables, and target executables of the distributed application. In FIG. 13B, the graph originally shown in FIG. 12 is annotated with “*” symbols to indicate the impacted source-code files and executables of the example distributed application. The source-code change 1302 includes changes, or updates, only to source-code file 1308. Changes to source-code file 1308 impact only first-layer intermediate executable 1310. In turn, changes to executable 1310 affects only second-layer intermediate executable 1210. Changes to executable 1210 affects both target-layer executable 1220 and target-layer executable 1224. Thus, changes to a single source-code file can impact multiple different intermediate executables and target executables. A submitted source-code change can, as further discussed below, affect more than a single source-code file. In such cases, the number of impacted intermediate-layer and target-layer executables often increases.

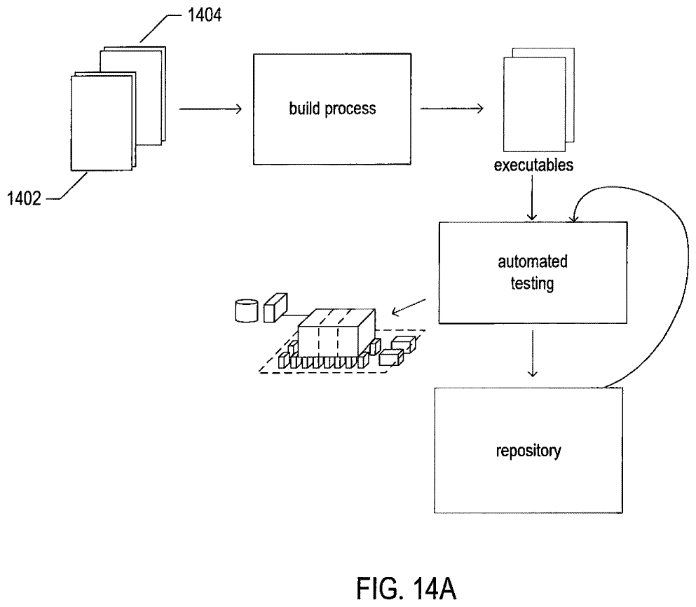

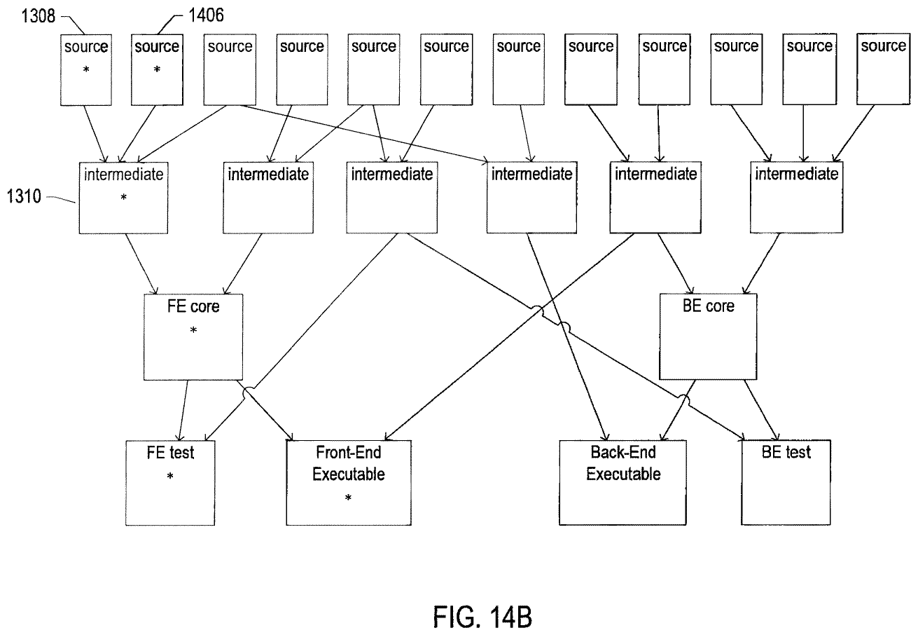

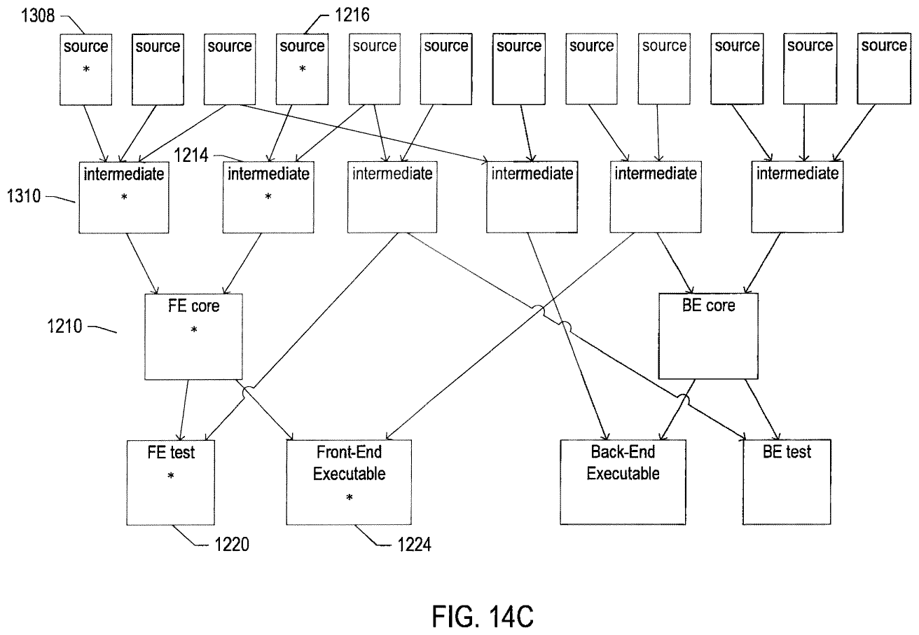

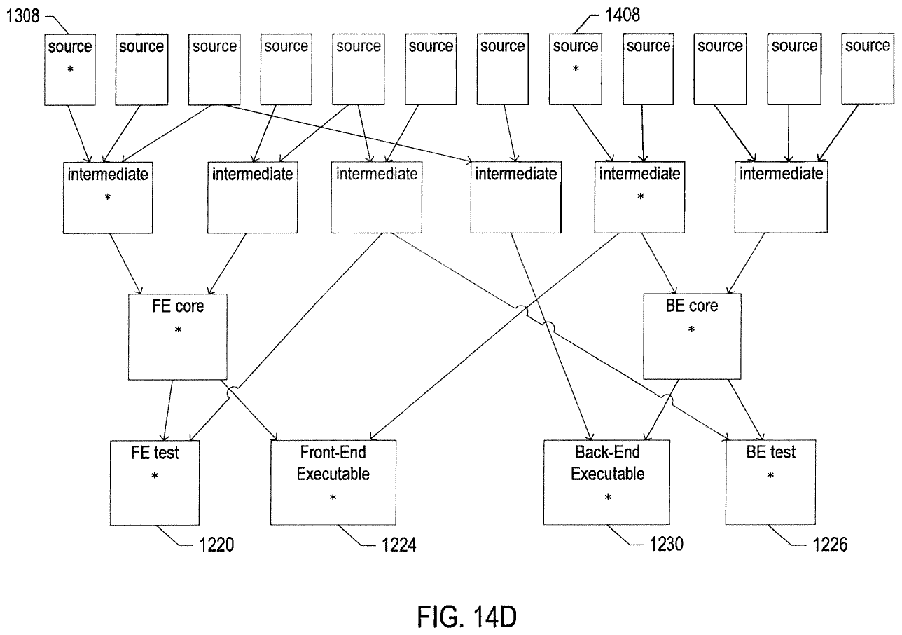

FIGS. 14A-D illustrate processing of two source-code changes by the continuous-integration and continuous-delivery/deployment functionalities of the automated application-development-and-release-management system, using the same illustration conventions as used in FIGS. 13A-B. The two source-code changes 1402 and 1404 can be viewed as either two changes to two different source-code files that together constitute a single source-code change submitted by a user of the continuous-delivery/deployment functionalities of the automated application-development-and-release-management system or they can be viewed as two different source-code changes submitted by two different users, each affecting a single source-code file. Both interpretations are considered below. The source-code changes are processed in similar fashion to the processing of source-code change 1302 discussed above with reference to FIG. 13A.

FIG. 14B illustrates the impact of the source-code changes 1402-1404 to the nodes of the graph for the distributed application using the same illustration conventions as used in FIG. 13B. In the example of FIG. 14B, the first source-code change impacts source-code file 1308 and the second source-code change impacts source-code file 1406. Both changes impact only first-intermediate-layer executable 1310, and the remaining lower-level executables impacted by the two source-code changes are identical to the impacted lower-level executables shown in FIG. 13B. FIG. 14C also illustrates the impact of the source-code changes 1402-1404 to the nodes of the graph for the distributed application using the same illustration conventions as used in FIG. 13B. However, in the example shown in FIG. 14C, the first source-code change impacts source-code file 1308 while the second source-code change impacts source-code file 1216. As a result, in addition to the lower-level nodes 1310, 1210, 1220, and 1224, intermediate executable 1214 is also impacted, since it is a child of source-code file 1216 altered by the second source-code change. This demonstrates that, as more source-code files are impacted by a source-code change, it is possible that more intermediate executables and target executables may be impacted. This is shown even more dramatically in FIG. 14D, where the two source-code changes impact source-code file 1308 and source-code file 1408, with the two impacted source-code files resulting in all four target-layer executables 1220, 1224, 1226, and 1230 being impacted by the source-code changes.

When the two source-code changes 1402 and 1404 in FIG. 14A represent two different source-code changes submitted by two different users, the patterns of impacted graph nodes shown in FIGS. 14B-D illustrate how two different source-code changes can impact different numbers of intermediate executables and target executables depending on the source-code files altered by the two different source-code changes. The number of impacted source-code files, intermediate executables, and target executables impacted by both source-code changes is a measure of how closely related the two source-code changes are to one another. When the two different source-code changes alter only a single source-code file, as in FIG. 14B, the two different source-code changes are closely related and therefore impact a relatively small number of intermediate and target executables. By contrast, when the two different source-code changes alter two different source-code files that indirectly impact only a single common second-layer intermediate executable, as is the case in the example shown in FIG. 14C, the two different source-code changes are less closely related to one another than the two different source-code changes discussed with reference to FIG. 14B, but are still at least somewhat related to one another. However, in the example shown in FIG. 14D, the two different source-code changes impact many more intermediate executables and target executables, and are therefore even less closely related to one another. Both of the source-code changes in FIG. 14C impact only the front-end executable and front-end test executable, and are thus related in the sense that the two source-code changes are directed to the front-end instances of the distributed application. The two source-code changes in FIG. 14D impact both the front-end and back-end instances of the distributed application, although each of the source-code changes in FIG. 14D impact only one of the front-end and back-end instances of the distributed application, and so the two source-code changes in FIG. 14D are clearly less related to one another than the two different source-code changes in FIG. 14C. Of course, each source-code change may affect multiple different source-code files, leading to more complex patterns of impacted intermediate and target executables. The relatedness or relevance of different source-code changes and a method for evaluating the relatedness of different source-code changes are discussed in greater detail, below.

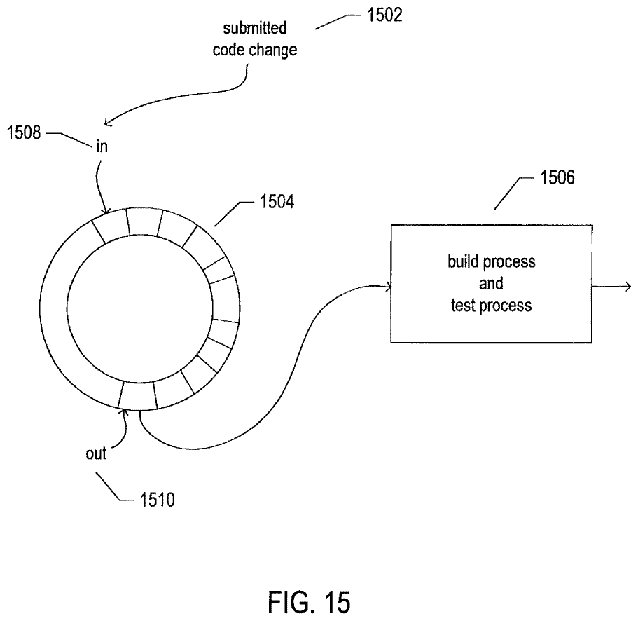

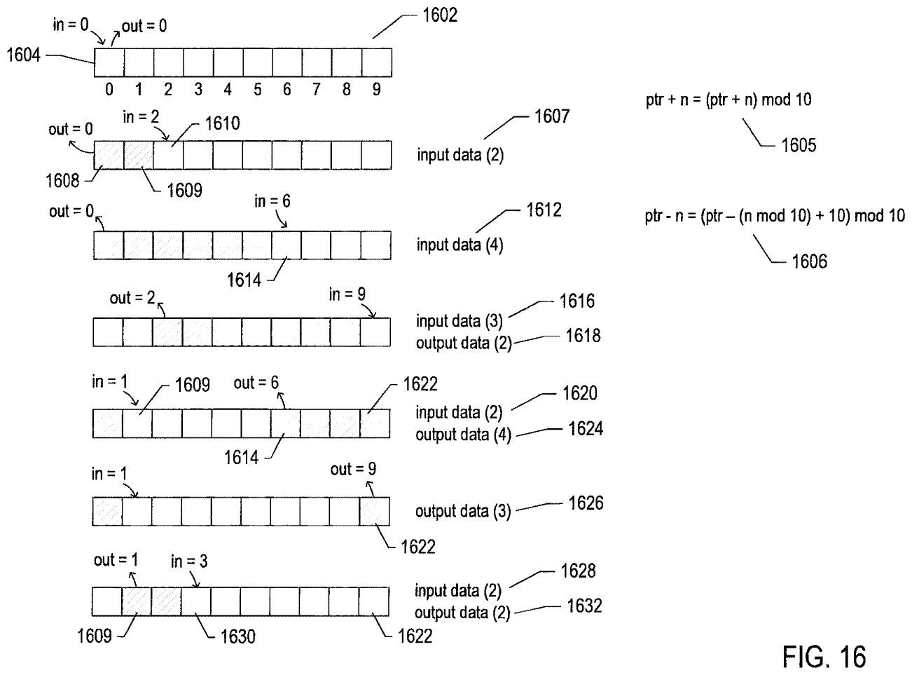

FIG. 15 illustrates a general mechanism for input of submitted code changes to the continuous-delivery/deployment functionalities of the automated application-development-and-release-management system. A submitted code changes 1502 is queued to a circular queue 1504 and subsequently dequeued from the circular queue for input to the build and test processes 1506 of the automated application-development-and-release-management system. Circular queues, discussed below with reference to FIG. 16, are logically circularized code-change buffers implemented in memory, mass storage, or a combination of memory and mass storage. The circular queue includes an in pointer 1508 that references the next free code-change-storage space into which a next code change can be entered and includes an out pointer 1510 that references the least recently stored entry in the circular queue that can be dequeued and input to the build and test processes 1506. Circular queues are commonly used as buffers accessed by multiple asynchronous processes. In the current discussion, submitted code changes may either be relatively quickly processed by the automated application-development-and-release-management system or merged with already waiting code changes, or processing may be delayed in order to attempt to merge the submitted code changes with additional, subsequently submitted code changes. In the described implementation, one circular queue is used as a buffer between the asynchronous submission of code changes and processing of code changes and another circular queue is used for storing code changes, both for subsequent predictions of the likelihood of subsequent relevant code changes being submitted and for delaying processing of certain code changes in order to attempt to merge the code changes with subsequently submitted code changes. In the described implementation, code changes are directly submitted for both building of executables and for testing and verification. However, it is also possible to separate the build process from the test and verification process, and carry out builds for code changes waiting for testing and verification so that the build portion of the overall process can be completed before initiation of testing and verification. It is the testing and verification portion of the process that constitutes both a potential processing bottleneck and the greatest usage of computational resources, and the currently disclosed methods were developed in order to facilitate merging of code changes in order to amortize the computational costs of testing and verification over as many concurrent code changes as possible. The methods disclosed, below, can be used in either the approach of submitting code changes to the entire build and test/verification process or the approach of carrying out the build process while code changes are waiting for testing and verification.

FIG. 16 illustrates implementation of a circular queue from a linear buffer. In a simple example shown in FIG. 16, a linear buffer 1602 with 10 slots for storing data is employed. The in and out pointers are both initialized to reference the first slot with index 0 1604. Modulo arithmetic is used for incrementing and decrementing these pointers, as indicated by expressions 1605-1606. When a pointer is to be incremented by n slots, n is added to the pointer and then the sum is integer divided by 10 modulo 10. This has the effect of essentially wrapping pointers incremented past the final slot of the linear buffer around to a slot within the linear buffer and wrapping pointers decremented past the first slot of the linear buffer around to a slot within the linear buffer.

Use of modulo arithmetic for incrementing or decrementing pointers transforms the linear buffer into a circular buffer. This is illustrated in a series of input and output operations in FIG. 16. In a first input operation 1607, a two-slot entry is made to the circular queue, with the slots 1608-1609 containing the entered data shown crosshatched in FIG. 16. The in pointer is incremented by 2 to reference slot 1610 following input of the data. In a second input operation 1612, a four-slot amount of data is input to the circular queue and the in pointer is correspondingly advanced to reference slot 1614. Next, a three-slot amount of data is input 1616 and, concurrently, the initial two-slot data entered in the first input operation 1607 is output from the circular queue 1618. Next, a two-slot amount of data is input to the circular queue and input operation 1620. This advances the in pointer past the final slot 1622 and, therefore, the in pointer wraps around and advances to point to slot 1609. A concurrent output operation 1624 advances the out pointer to slot 1614. An output operation 1626 advances the output pointer to slot 1622. A next input operation 1628 advances the in pointer to slot 1630 and a concurrent output operation 1632 causes the out pointer to be advanced past the final slot 1622 and wrap around to reference slot 1609. There are many additional ways to buffer data, but circular queues are used in the current discussion for ease of illustration and description.

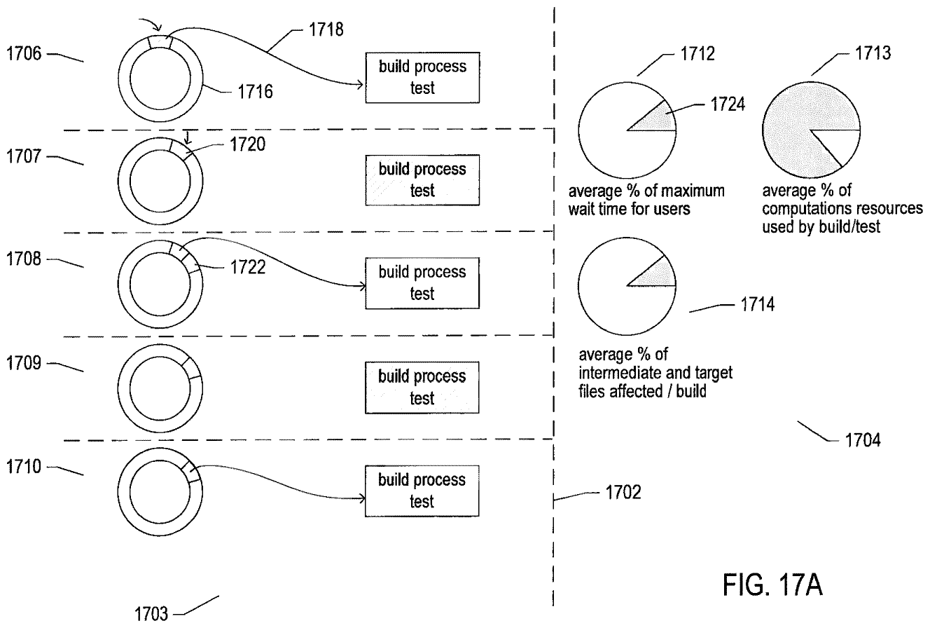

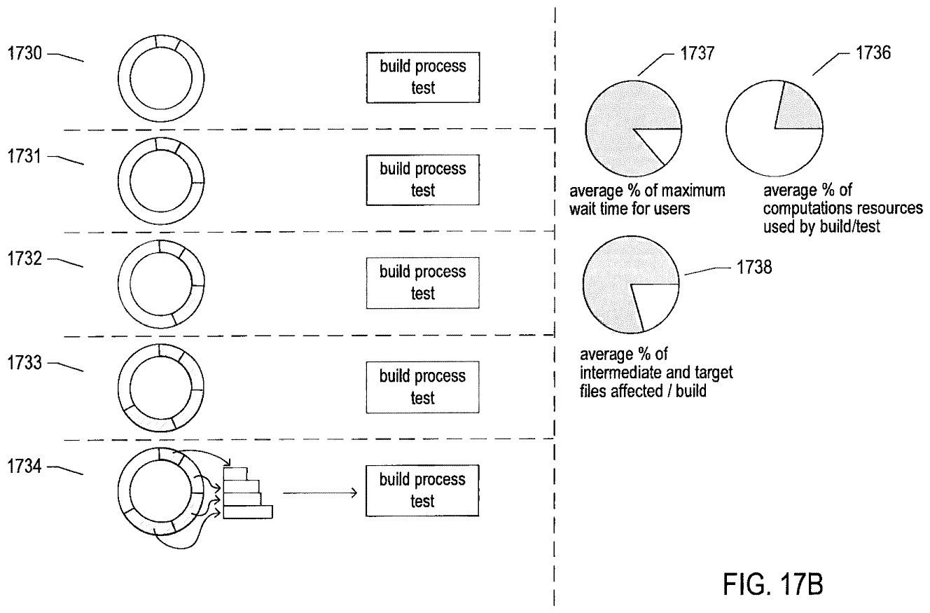

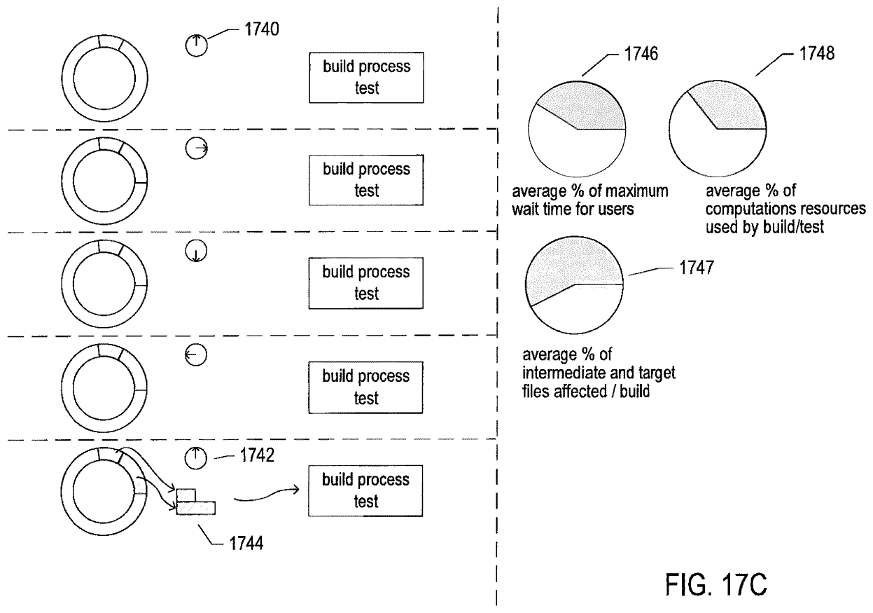

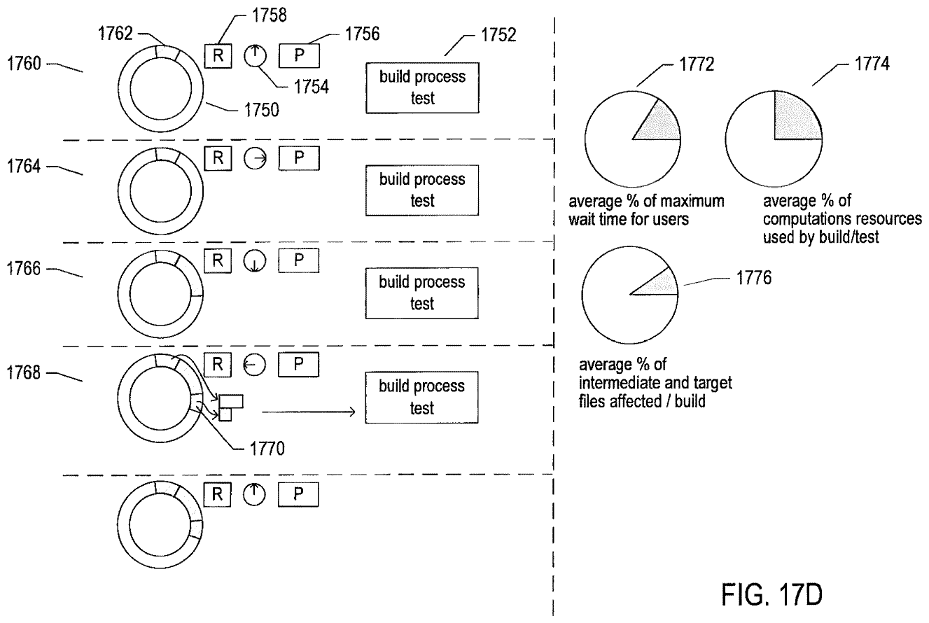

FIGS. 17A-D illustrate various trade-offs involved in different approaches to managing submitted code changes. All four of FIGS. 17A-D use the same illustration conventions, next described with reference to FIG. 17A. FIG. 17A is divided by vertical dashed line 1702 into a left-hand portion 1703 and a right-hand portion 1704. The left-hand portion 1703 is further divided into five sections or panels, such as panel 1706, that together represent a sequence of steps in time. Each step concerns a circular queue storing code changes for input to build and test processes of the continuous-delivery/deployment functionalities of the automated application-development-and-release-management system. The right-hand portion of FIG. 17A shows three different disks 1712-1714, or pie charts, representing percentages of a total value. The shaded portions of the disks represent average percentages of time or computational resources used by the method illustrated in the left-hand portion of FIG. 17A.

FIG. 17A illustrates a first approach to processing submitted code changes by the continuous-delivery/deployment functionalities of the automated application-development-and-release-management system. In panel 1706, a first code change is received from a user and input to circular queue 1716. The computational resources used for building and testing code changes is currently either unused or has spare capacity, and therefore the input code change is immediately retrieved from the circular queue by the continuous-delivery/deployment functionalities of the automated application-development-and-release-management system for processing, as indicated by curved arrow 1718. In panel 1707, cross hatching is used to show that the build and test components of the continuous-delivery/deployment functionalities of the automated application-development-and-release-management system are now fully used. Therefore, a newly submitted code change is entered 1720 into the circular queue in order to wait until computational resources are available for building and testing test functionality for the code change. In panel 1708, a new code change is received and entered 1722 into the circular queue and, since the building and testing components have finished processing the initial code change received in panel 1706, the code change 1720 added to the circular queue in panel 1707 can now be submitted to the continuous-delivery/deployment functionalities of the automated application-development-and-release-management system for processing. In panel 1709, code change 1720 is being processed by the build and testing components of the continuous-delivery/deployment functionalities of the automated application-development-and-release-management system. Finally, in panel 1710, processing of code change 720 has finished and code change 1722 input to the circular queue in panel 1708 can now be submitted to the continuous-delivery/deployment functionalities of the automated application-development-and-release-management system. Thus, in this first method considered in FIG. 17A, code changes are processed as quickly as possible by the continuous-delivery/deployment functionalities of the automated application-development-and-release-management system. When there are insufficient computational resources for building and testing a code-change-test executable for a submitted code change, the code change waits in the circular queue until there are sufficient computational resources for processing the code change.

The right-hand side of FIG. 17A provides indications of certain fundamental trade-offs associated with the method of code-change processing illustrated in FIG. 17A. As shown by disk, or pie chart, 1712, the average wait time experienced by a user, shown as a percentage of some maximum wait time in the shaded portion of the disk 1724, is relatively small. Of course, this depends on the rate at which code changes are submitted and, when that rate increases, the average wait time experienced by users also increases.

As shown by disk, or pie chart, 1713, a large percent of the available computational resources for building and testing code changes tends to be used, since each code change is individually processed and, when the rate of submission of code changes is greater than a threshold value, the computational resources for building and testing code changes tend to represent a bottleneck for code-change-processing throughput. The testing and validation of code changes often involves launching multiple different virtual machines to simulate the many different types of instances of a distributed application that together cooperate to implement the distributed application. In addition, testing and verification involves significant networking and data-storage overheads. When code changes are individually processed, there is no sharing of the computational-resource overheads among multiple code changes, and therefore a maximum overall usage of computational resources is generally observed.

As shown by disk, or pie chart, 1714, the average percentage of intermediate-executable and target-executable files impacted by a submitted code change, as discussed above with reference to FIGS. 13B and 14B-D, is relatively small. This is a positive feature of the immediate- and processing method shown in FIG. 17A because, when the number of impacted intermediate-executable and target-executable files is small, there is a good chance that a user will be able to understand and correct problems revealed during testing. In the example of FIG. 14B, when the two code changes 1402 and 1404 shown in FIG. 14A represent two different code-change submissions, when the two different code-change submissions are aggregated into a single code change for which test executables are built and tested, and when the two different code-change submissions affect only a single first-layer intermediate executable, only the front-end functionality of the distributed application is impacted. When the users specialize in the front-end portion of the distributed application, it is likely that problems revealed during testing will lie within the domains of both users' experience and knowledge. By contrast, in the example of FIG. 14D, when the two code changes 1402 and 1404 shown in FIG. 14A represent two different code-change submissions, when the two different code-change submissions are aggregated into a single code change for which test executables are built and tested, when the two different code-change submissions affect both front-end and back-end target executables, and when one of the users specializes in the front-end portion of the distributed application and the other user specializes in the back-end portion of the distributed application, neither user may have the experience or background to quickly diagnose and correct problems revealed during testing, since, for example, the user experienced in the front-end portion of the distributed application may have insufficient knowledge to recognize whether problems associated with the back-end portion of the distributed application are related to that user's code changes or to the code changes, made by the other user, that were merged into the aggregate code-change submission.

Thus, the processing of individual code changes as quickly as possible by the continuous-delivery/deployment functionalities of the automated application-development-and-release-management system, under low to medium code-change-submission loads, includes both positive trade-offs with respect to average user wait times and average percentages of impacted executables and a negative trade-off with respect to the computational resources needed for building and testing the submitted code changes. This latter negative trade-off may often outweigh the wait-time and executable-impact advantages of the method illustrated in FIG. 17A, since computational resources are expensive to purchase and maintain or rent from cloud-computing providers.

FIG. 17B illustrates a second possible method for processing code changes using the same illustration conventions used in FIG. 17A. In this approach, submitted code changes are queued until there are more than a threshold number of code changes waiting on the circular queue, at which point the waiting code changes are merged together into an aggregate code change and submitted to the continuous-delivery/deployment functionalities of the automated application-development-and-release-management system, as shown in the sequence of panels 1730-1734. This approach is associated with nearly opposite trade-offs in comparison to the approach discussed above with reference to FIG. 17A. Because code changes are aggressively merged with one another, the computational resources used for building and testing code changes are amortized over groups of code changes, rather than used for building and testing individual code changes. Therefore, the average percentage of the computational resources devoted to building and testing code changes is relatively low, as indicated by pie chart 1736. However, the average wait time for users is much greater, as shown in pie chart 1737, and the average impact of an aggregated code change is much higher, as indicated by pie chart 1738. Again, these percentages are estimates and depend on the rate of code-change submissions and the complexities of the submitted code changes, but, nonetheless, the approach illustrated in FIG. 17B generally results in more efficient use of computational resources at the expense of increasing user wait times and increasing the percentage of impacted intermediate and target executables which, in turn, tends to decrease the efficiency and ability of users to understand the problems that arise during testing.

FIG. 17C illustrates a third approach to processing submitted code changes. In this approach, similar to the approach discussed above with reference to FIG. 17B, a timer, indicated by icon 1740, is used to time the waiting periods for code changes entered into the circular queue. Upon timer expiration 1742, the code changes currently waiting in the circular queue are aggregated into a single aggregated code change 1744 and submitted to the continuous-delivery/deployment functionalities of the automated application-development-and-release-management system. As shown in pie chart 1746, the average wait time for users is substantially decreased with respect to the method illustrated in FIG. 17B, and the average impact of the code change on intermediate and target executables is somewhat decreased, as shown in pie chart 1747. These favorable decreases are slightly offset by a modest increase in the percentage of computational resources used for processing submitted code changes, indicated by pie chart 1748. Thus, the approach shown in FIG. 17C appears to be an improvement over the approaches discussed above with reference to FIGS. 17A-B, particularly when the amount or capacity of computational resources used for processing code changes is considered to be of prominent significance.

FIG. 17D illustrates, in overview, one implementation of the currently disclosed methods for processing code changes. In addition to the circular queue 1750 and the rectangle representing the build and testing/verification processes 1752, the panels in FIG. 17D include a timer icon 1754, a prediction module 1756, and a relevance module 1758. The timer icon 1754 represents the fact that each entry entered into the circular queue is associated with a timestamp that is monitored so that no entry waits for more than some maximum wait time before being submitted for processing to the continuous-delivery/deployment functionalities of the automated application-development-and-release-management system. The prediction-module icon 1756 indicates that a prediction is made, for each submitted code change entered into the circular queue, as to whether additional code changes are likely to be submitted with which the code change can be merged during a period of time less than or equal to the maximum wait time. The relevance-module icon 1758 indicates that two different code changes are merged only when the relevance of one of the code changes with respect to the other of the code changes is greater than a threshold relevance. This essentially means that code changes are merged when the degree to which intermediate and target executables will be impacted is less than some threshold value. This increases the likelihood that problems that arise during testing of an aggregated code change can 1023 CN WO be diagnosed and corrected by all of the users associated with an aggregated code change. As shown in panel 1760, an initially submitted code change has been entered into the circular queue 1762. This is because the prediction model determined that it is sufficiently likely that a subsequent code change with which the entered code change can be merged will be submitted within the maximum wait time for the initially submitted code change. In panels 1764 and 1766, time passes and a few additional code changes are submitted and entered into the circular queue. In panel 1768, either the initially submitted code change has reached its maximum wait time on the circular queue or it is determined that it will be unlikely that any additional code changes will be submitted with which it can be merged. In addition, the most recently submitted code change 1770 is deemed to have more than a threshold relevance to the initially submitted code change, so these two code changes are merged and submitted to the continuous-delivery/deployment functionalities of the automated application-development-and-release-management system for processing. Greater details with respect to the currently disclosed methods for code-change processing are provided below.

As can be seen in the right-hand side of FIG. 17D, the currently disclosed methods for code-change processing provide positive trade-offs in all cases. The average wait times for users is low, as shown in pie chart 1772, the amount of computational resources devoted to code-change processing is relatively low, as shown in pie chart 1774, and the extent of impacts to intermediate and target executables by code changes is low, as shown in pie chart 1776. Again, as with FIGS. 17A-C, the actual percentages very with regard to the rate of code-change submissions, the complexities of the submitted code changes, and other factors and parameters, but, in general, the currently disclosed methods provide favorable trade-offs with regard to user wait times, use of computational resources for processing code changes, and the extent of the impacts of code changes to the intermediate and target executables generated for the distributed application.

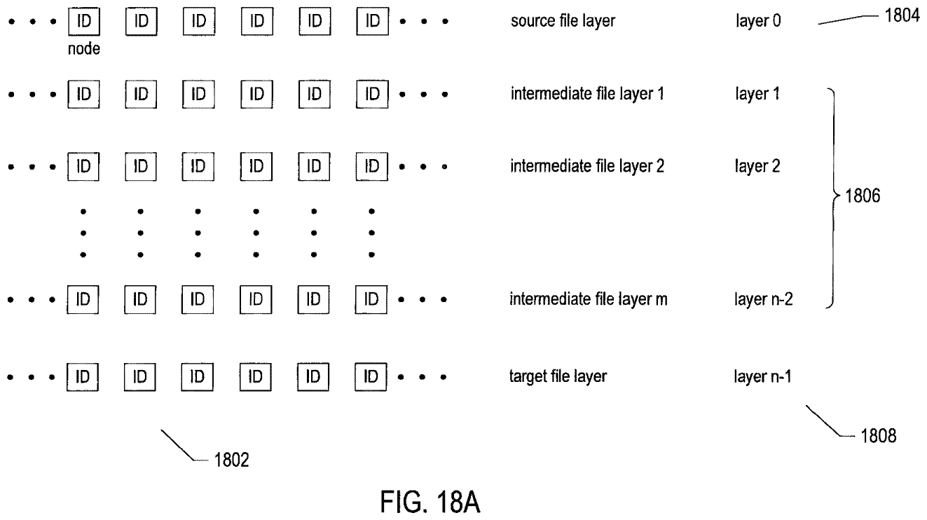

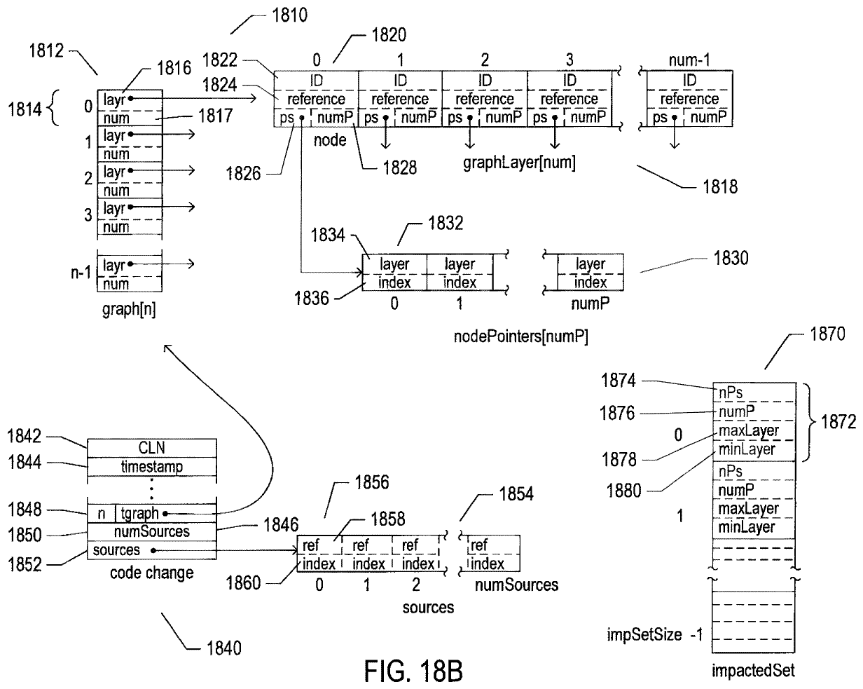

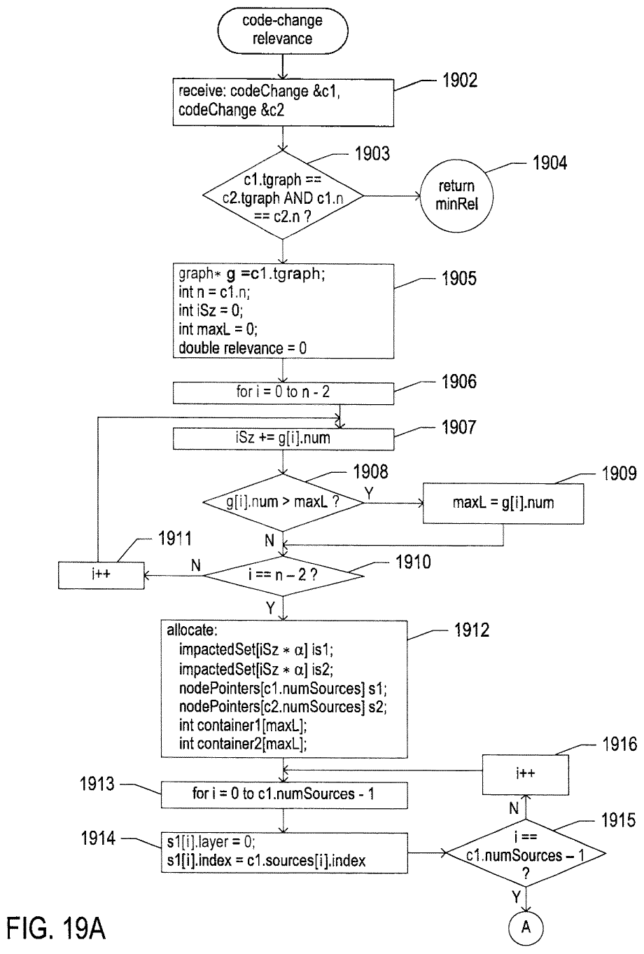

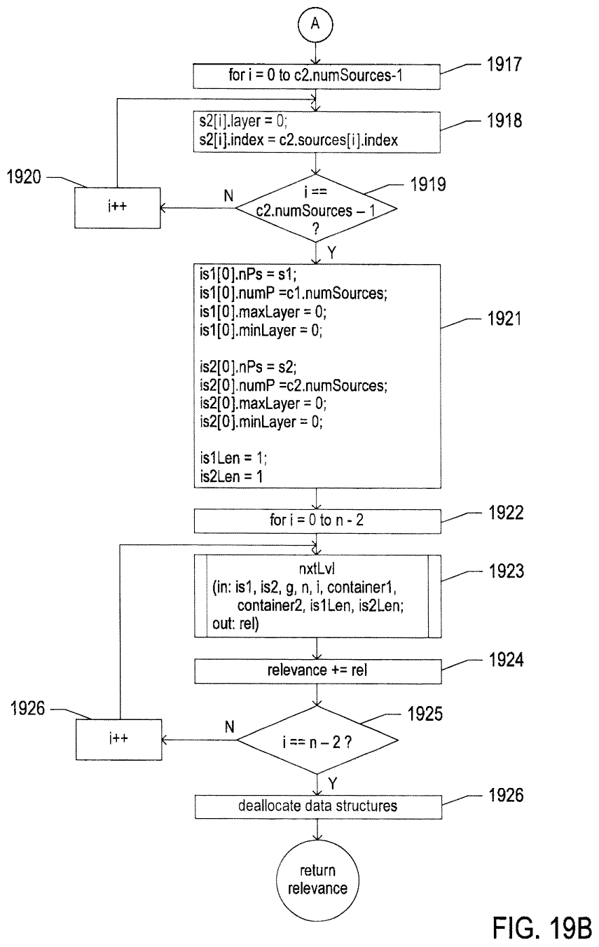

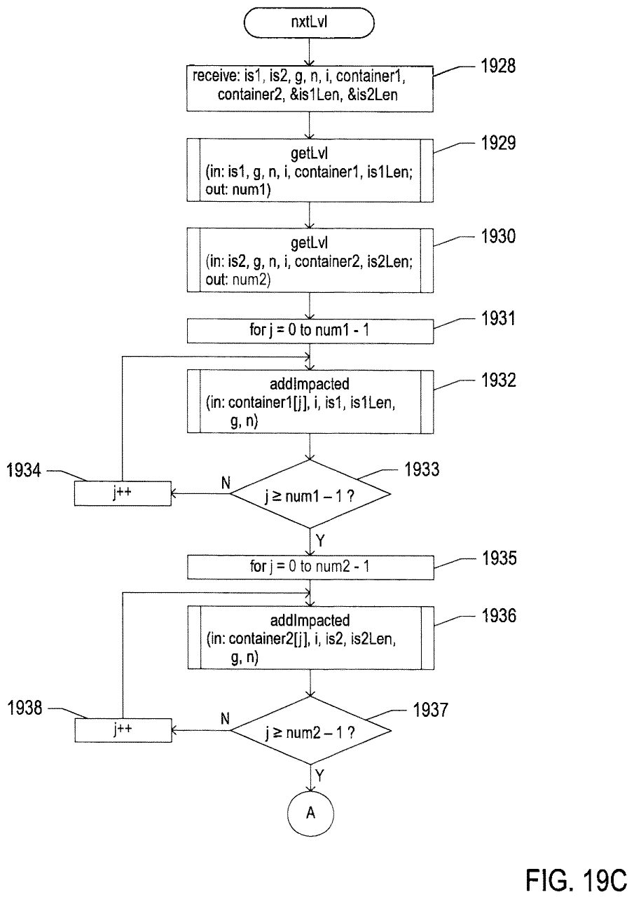

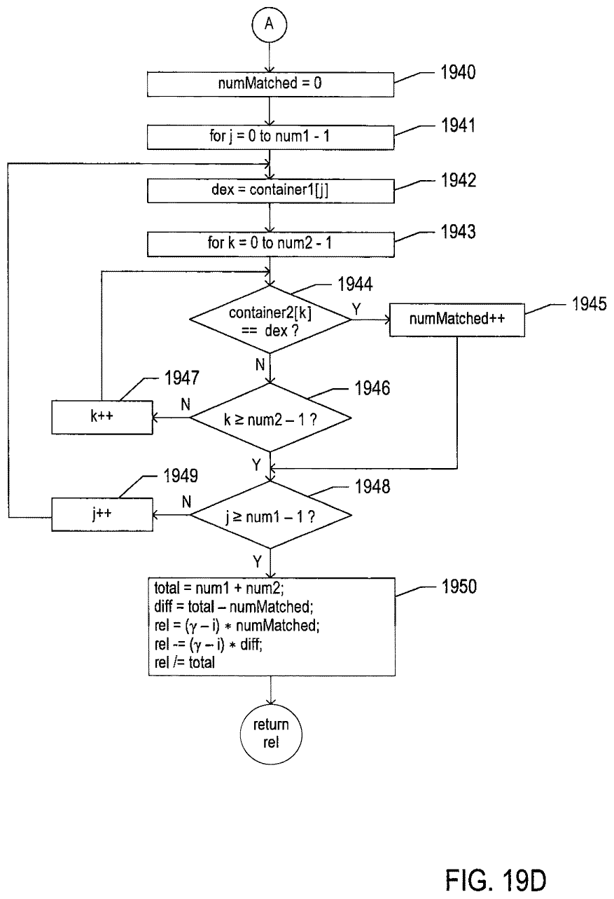

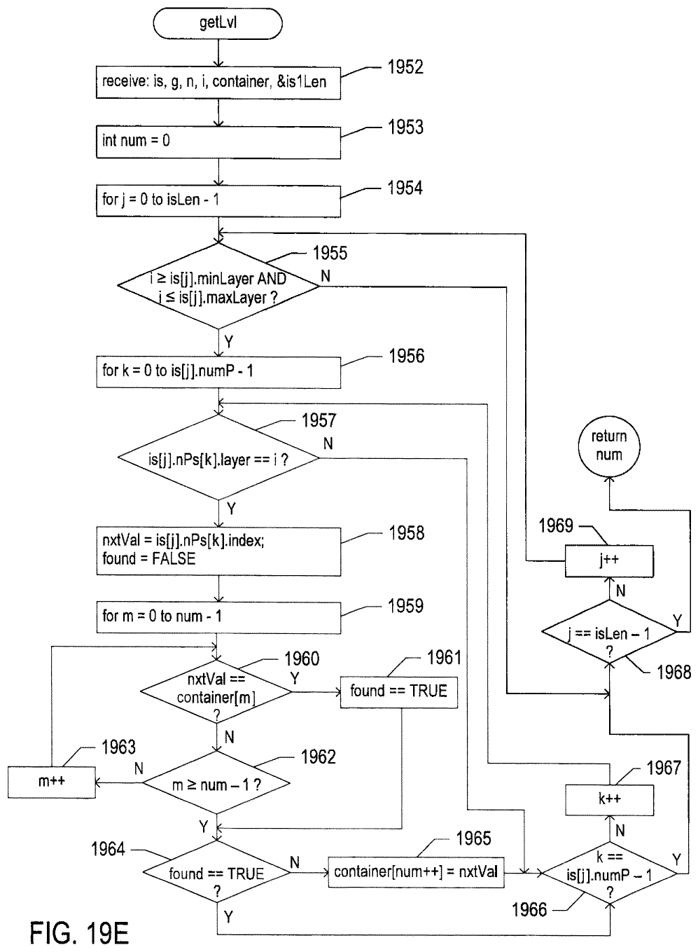

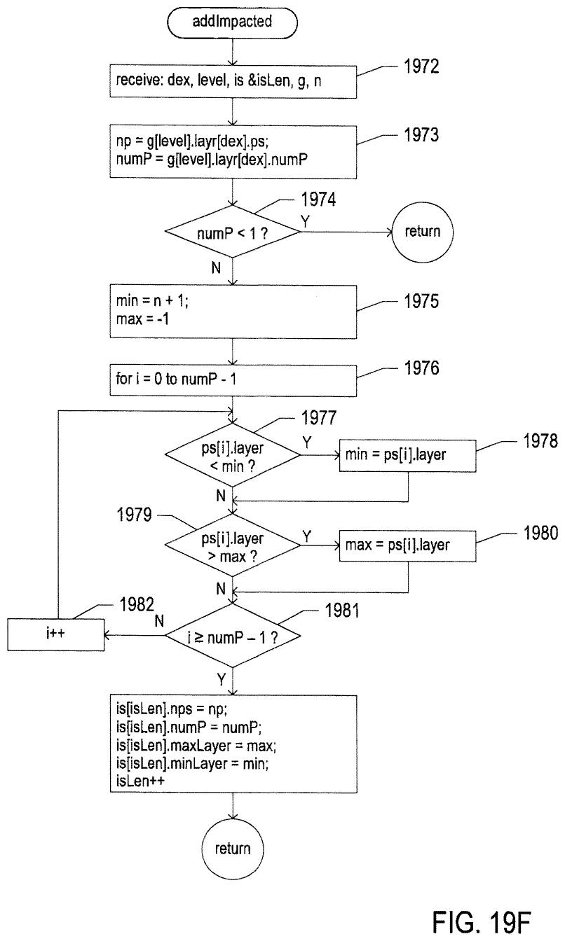

FIGS. 18A-B illustrate data structures used in control-flow diagrams discussed with reference to FIGS. 19A-F and 21-25, which illustrate one implementation of the currently disclosed methods and subsystems. There are many different possible data structures that can be used in various different alternative implementations. In certain implementations, for example, graphs may be encoded in extended markup-language (“XML”) or JSON. The data structure illustrated in FIGS. 18A-B are examples of the many different possible data structures. The graph, or topological graph, indicating the relationships between source-code files, intermediate executables, and target executables is represented, as illustrated in FIG. 18A, by a set of nodes 1802, each associated with an identifier for the source-code file or executable represented by the node, and organized into node layers. Layer 0 includes nodes representing source-code files 1804. There are n−2 layers of nodes representing layers of intermediate executables 1806 and a final layer of nodes representing target executables 1808, for a total of n different node layers in the graph. The nodes in each layer are each associated with an index, where the index of the first node in a layer is 0 and the indexes monotonically increase for each successive node in the layer. Each node can therefore be uniquely identified by a layer/index pair.

FIG. 18B shows three different data structures used in subsequently discussed control-flow diagrams. A first data structure 1810 represents the graph, or topological graph, that represents dependencies between source-code files, intermediate executables, and target executables. An array graph[n] 1812 includes an entry or element for each node layer, therefore containing a total of n entries indexed from 0 to n−1. Each entry, such as entry 1814, includes a reference layr 1816 to a graphLayer array 1818 and an indication num 1817 of the number of entries in the graphLayer array. The graphLayer array contains num entries or elements, each representing a graph node within the node layer represented by the graphLayer array. Each element of a graphLayer array contains a node data structure such as node data structure 1820. The node data structure includes an identifier for the file represented by the node 1822, a reference to the file 1824, a reference ps to a nodePointers array 1826, and the number of entries in the nodePointers array referenced by reference ps, numP 1828. A nodePointers array, such as nodePointers array 1830, includes elements representing links or edges in the graph, or topological graph, represented by the graph data structure. The links or edges in the nodePointers array referenced from a node data structure are the links or edges emanating from the node to nodes in lower node layers of the graph. An element in the nodePointers array, such as element 1832, includes an indication layer of the node layer 1834 and an index index within the node layer 1836 of a lower-layer node referenced by the node 1820 that references the nodePointers array.

The codeChange data structure 1840 represents a code change, or code-change request, submitted to the continuous-delivery/deployment functionalities of the automated application-development-and-release-management system for processing. The codeChange data structure includes a code-change identifier 1842, a timestamp 1844, a reference, or pointer, tgraph to a topological graph 1846, an indication n of the number of layers in the graph 1848, an indication numSources of the number of source-code files associated with the code change 1850, and a reference sources 1852 to a sources array containing references to the code-change source-code files. A sources array 1854 includes numSources elements that each reference a source-code file. Each element in a sources array, such as element 1856 in sources array 1854, includes a reference ref to a source-code-change file 1858 and a source-layer index index1860. A source-code-change file may be a full replacement for the corresponding source-code file currently incorporated in an application or service or may simply indicate changes to the corresponding source-code file.

The array impactedSet 1870 represents the impacted nodes of a graph, or topological graph, corresponding to a code change. Each of the elements in an impactedSet array, such as element 1872, includes a pointer nPs to a nodePointers array 1874, an indication numP of the number of elements in the nodePointers array 1876, an indication maxLayer 1878 of the highest layer to which a node, referenced by the nodePointers array, belongs and an indication minlayer 1880 of the lowest layer to which a node, referenced by the nodePointers array, belongs. An impactedSet array includes impSetSize elements. The meanings and use of the various fields and elements of the data structure shown in FIG. 18B are further described and clarified below.

FIGS. 19A-F provide control-flow diagrams that illustrate one implementation of a method for determining the relevance of two code changes, carried out by the currently disclosed methods and subsystems in order to determine whether or not to merge code changes into an aggregate code change. FIGS. 19A-B provide control-flow diagrams for a routine “code-change relevance” which computes a relevance value for two code changes. This is a numerical value, with values of greater magnitudes representing greater relevance. The value generally reflects the numbers of files impacted by both code changes, with impacted files at lower layers contributing more to the relevance value than files at higher layers, where the lowest layer is layer 0, the layer representing source-code files. In step 1902, the routine “code-change relevance” receives references to two codeChange data structures c1 and c2. When the two referenced codeChange data structures fail to contain references to the same graph and indications of the same number of layers in the graph, as determined in step 1903, the routine “code-change relevance” returns a minimal relevance value, in step 1904, since the two codeChange data structures apparently reference different graphs for different applications. Otherwise, in step 1905, the routine “code-change relevance” initializes a number of local variables: (1) g, a pointer to the graph, or topological graph, referenced from the received codeChange data structures: (2) n, the number of layers in the graph referenced by local variable g; (3) iSz, a local variable that is used to determine the number of nodes in the graph referenced by local variable g; (4) maxL, a local variable used to determine the number of nodes in the layer of the graph referenced by local variable g containing the maximum number of nodes; and (5) relevance, a local variable in which a computed relevance value is stored for return to the caller of the routine “code-change relevance.”

In the for-loop of steps 1906-1911, the routine “code-change relevance” considers each layer in the graph referenced by local variable g, except for the final node layer corresponding to the target executables, in order to determine the number of nodes in the graph and the maximum number of nodes in any layer of the graph. For each layer of the graph, the number of nodes at that layer is added to the local variable iSz, in step 1906. When the number of nodes in the currently considered layer is greater than the value stored in local variable maxL, as determined in step 1908, maxL is updated to store the number of nodes in the currently considered layer, in step 1909. In step 1912, the routine “code-change relevance” allocates a number of data structures including: (1) to impactedSet data structures is1 and is2; (2) two nodePointers data structures s1 and s2; and (3) two integer arrays container1 and container2. In the for-loop of steps 1913-1916, the routine “code-change relevance” initializes the nodePointers array s1 to contain references to the source-code tiles contained in the sources array of the first received codeChange data structure c1 and, in a second for-loop of steps 1917-1920, in FIG. 19B, initializes the nodePointers array s2 to contain references to the source-code files contained in the sources array of the second received codeChange data structure c2. In step 1921, the routine “code-change relevance” initializes the two impactedSet data structures to include, as first elements, references to the source-code files contained in nodePointers data structures s1 and s2. The two local variables is1Len and is2Len are both initialized to the value 1, indicating that the two impactedSet data structures is) and is2 both contain a single element.

In the for-loop of steps 1922, the routine “code-change relevance” calls the routine “nxtLvl” for each layer of the graph referenced by local variable g other than the final target-executable layer of the graph. The routine “nxtLvl” computes a relevance score that is added to the local variable relevance, in step 1924, for each layer of the graph considered in the for-loop of steps 1922-1926. Finally, in step 1926, the routine “code-change relevance” deallocates the data structures allocated in step 1912 of FIG. 19A and returns the value stored in local variable relevance.

FIGS. 19C-D provide control-flow diagrams for the routine “nxtLvl,” called in step 1923 of FIG. 19B. In step 1928, the routine “nxtLvl” receives two impactedSet data structures is1 and is2, a reference g to a graph, an indication n of the number of nodes in the graph, the layer of the graph i to consider, two integer arrays container) and container2, and references to the variables containing the lengths of the two impactedSet data structures is1Len and is2Len. In step 1929, the routine “nxtLvl” calls a routine “getLvl” to retrieve, into the index array container), the indexes of the nodes in layer i impacted by the first code change, and, in step 1930, the routine “nxtLvl” calls the routine “getLvl” to retrieve, into the index array container2, the indexes of the nodes in layer i impacted by the second code change. In the for-loop of steps 1931-1934, the routine “nxtLvl” calls a routine “addImpacted” to add the impacted nodes in container) as elements to the impactedSet data structure is) and, in the for-loop of steps 1935-1938, the routine “nxtLvl” calls the routine “addImpacted” to add the impacted nodes in container2 as elements to the impactedSet data structure is2. In step 1940 of FIG. 19D, the routine “nxtLvl” sets local variable numMatched to 0. Then, in the nested for-loops of steps 1941, the routine “nxtLvl” determines the number of indexes that occur in both container1 and container2, which is the number of impacted nodes in layer i of the graph referenced by local variable g common to both code changes. The outer for-loop of steps 1941-1949 considers each index stored in container). The inner for-loop of steps 1943-1947 considers each index stored in container2. When the currently considered index in container2 matches the currently considered index in container1, as determined in step 1944, local variable numMatched is incremented, in step 1945. Finally, in step 1950, the routine “nxtLvl” computes the relevance value for the currently considered graph layer i. First, local variable total is initialized to contain the sum of the number of nodes in layer i impacted by the first and second code changes. Next, local variable diff is initialized to the difference between the total number of impacted nodes and the number of nodes in layer i impacted by both code changes. Local variable rel is initialized to the difference between a constant γ and the currently considered layer i times the number of nodes in layer i impacted by both code changes. Then, local variable rel is updated to contain the current contents of local variable rel minus the difference between a constant γ and the currently considered layer i times the value stored in local variable diff. The relevance value for layer i is thus equal to:

$$( γ - i ) ( \frac{numMatched - diff}{total} ) .$$

The relevance value thus falls in the range [−(γ−i), (γ−i)]. With increasing node layers, the relevance value falls in increasingly narrower ranges of values as i approaches γ.

FIG. 19E provides a control-flow diagram for the routine “getLvl,” called in steps 1929-1930 of FIG. 19C. In step 1952, the routine “getLvl” receives an impactedSet data structure is, a reference g to a graph, an indication n the number of nodes in the graph, a current graph layer i, an array of integers container, and a reference to an indication of the length of the impactedSet data structure, isLen. In step 1953, the routine “getl.vl” initializes local variable num to 0. In the triply nested for-loops of steps 1954-1969, the routine “getLvl” finds the indexes of nodes referenced from nodes in the impactedSet data structure in layer i in graph g. The outer for-loop of steps 1954-1969 considers each element in the impactedSet data structure is. When the range of graph layers of nodes referenced from the currently considered element does not include nodes in layer i, as determined in step 1955, control flows to step 1968, where the routine “getLvl” determines whether there is another element of the impactedSet data structure is to consider and, if so, returns control to step 1955 after incrementing the outer for-loop variable j in step 1969. If there are no further elements to consider, the routine “getLvl” returns the value stored in local variable num. In inner for-loop 1956-1967, each element of the nodePointers data structure referenced by the currently considered element of the impactedSet data structure is is considered. When the layer of the node referenced by the currently considered elements of the nodePointers data structure is not equal to layer i, as determined in step 1957, control flows to step 1966, where the routine “getLvl” determines whether or not there is another element in the nodePointers data structure to consider. If so, the loop variable is incremented, in step 1967 and control returns to step 1957 for another iteration of the inner for-loop of steps 1956-1967. Otherwise, in step 1958, local variable nxtVal is set to the index of the node referenced by the currently considered element of the nodePointers array and the local variable found is set to FALSE. Then, in the innermost for-loop of steps 1959-1963, the routine “getLvl” determines whether the array container already contains the index stored in local variable nxtVal. When the currently considered element of the array container is equal to nxtlVal, as determined in step 1960, local variable found is set to TRUE, in step 1961. Following completion of the for-loop of steps 1959-1963, the routine “getLvl” determines whether the local variable found contains the value TRUE, in step 1964. If not, the index stored in local variable nxtVal is entered in the array container and the local variable num is incremented, in step 1965.

FIG. 19F provides a control-flow diagram for the routine “addImpacted,” called in steps 1932 and 1936 in FIG. 19C. In step 1972, the routine “addImpacted” receives a node index dex, a graph layer level, an impactedSet data structure is, a reference to an indication of the length of the impactedSet data structure isLen, a reference g to a graph, and an indication n of the number of layers in the graph. In step 1973, the routine “addImpacted” sets local variable np to reference the nodePointers data structure referenced by the graph node in graph layer level with index dex and sets local variable numP to the number of references in the nodePointers data structure referenced by local variable np. When numP is less than 1, as determined in step 1974, the routine “addImpacted” returns. Otherwise, in step 1975, the routine “addImpacted” sets local variable min to n+1 and sets local variable max to −1. Then, in the for-loop of steps 1976-1982, the routine “addImpacted” determines the minimum and maximum layers of nodes referenced from the nodePointers data structure referenced by local variable np. At the conclusion of execution of the for-loop of steps 1976-1982, a new entry is added to the impactedSet data structure is to represent the nodes referenced by the graph node with index dex in node layer level.

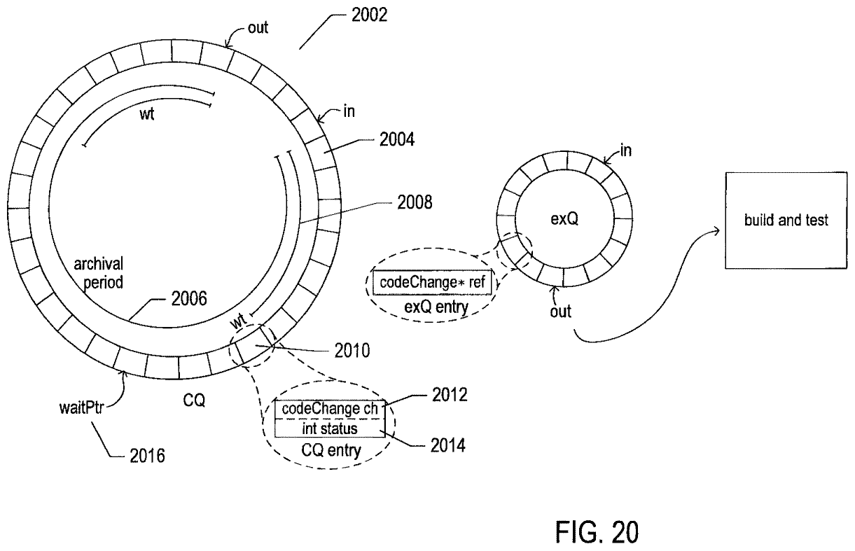

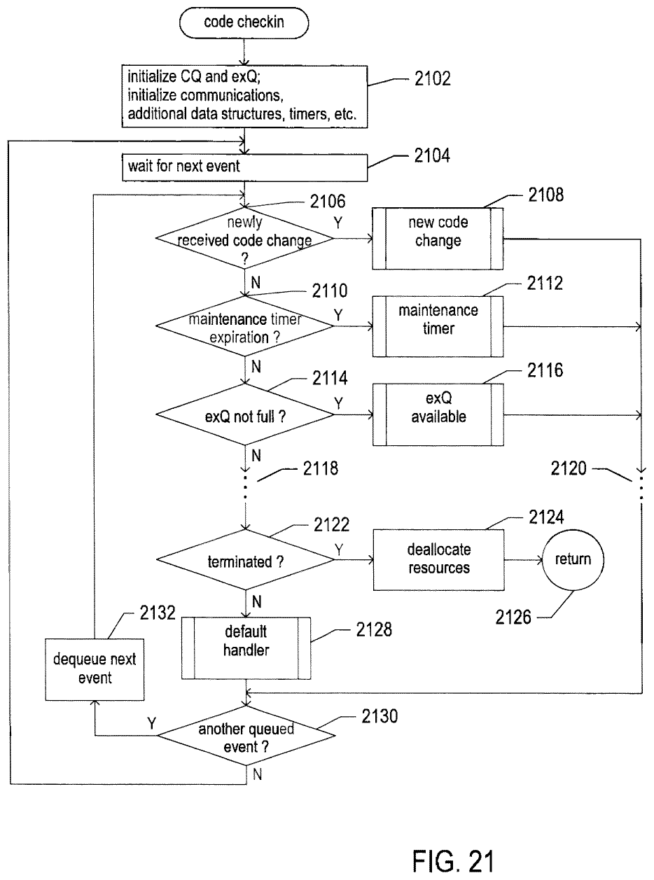

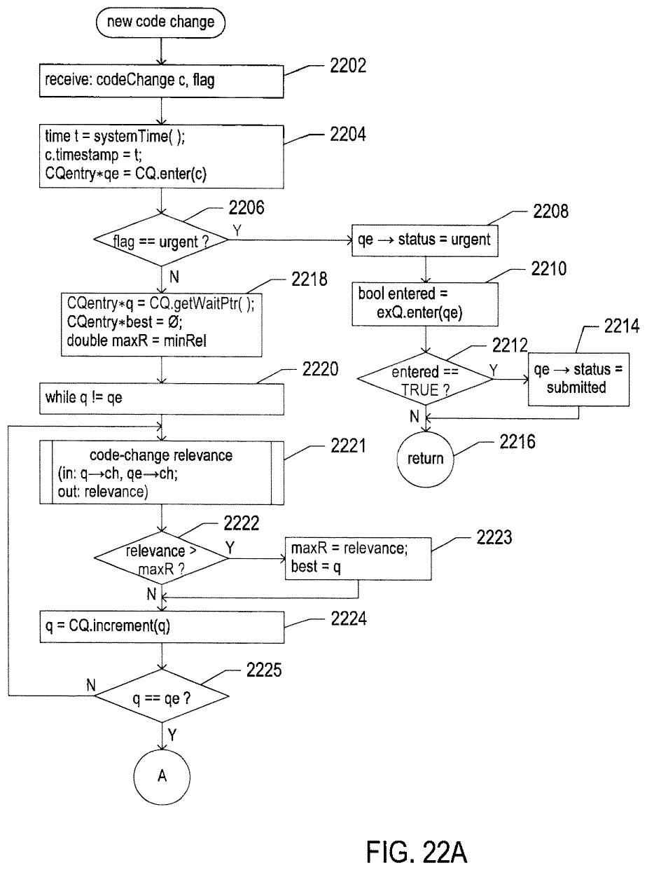

FIG. 20 illustrates data structures used in one implementation of the currently disclosed methods and subsystems discussed below with reference to FIGS. 21-25. A first circular queue CQ 2002 is used for storing submitted code-change requests for a time period referred to as the “archival period.” by arc 2006 for queued code-change request 2004. Waiting code-change requests remain on the circular queue CQ in the state “waiting” for up to a maximum length of time wt referred to as the “wait period,” indicated for queued code-change request 2004 by arc 2008. Each queued code-change request, such as queued code-change request 2010, includes either a codeChange data structure or a reference to a codeChange data structure 2012 and a status value 2014 indicating the current status of the code-change request. The circular queue CQ is additionally associated with a waitPtr pointer 2016 which indicates the least recently queued code-change request to be submitted to the continuous-delivery/deployment functionalities of the automated application-development-and-release-management system. A second circular queue exQ is used to queue code-change requests submitted for processing to the continuous-delivery/deployment functionalities of the automated application-development-and-release-management system. Each entry in the circular queue exQ contains a reference to a codeChange data structure. The second circular queue exQ is used to buffer code-change requests asynchronously submitted to the continuous-delivery/deployment functionalities of the automated application-development-and-release-management system for processing. The continuous-delivery/deployment functionalities of the automated application-development-and-release-management system dequeues and processes the code-change requests in exQ as quickly as possible. As discussed below, code-change requests flagged as being urgent are directly queued to the circular queue exQ, as are code-change requests with a low probability of being merged with subsequently submitted code-change requests.

FIG. 21 provides a control-flow diagram for the routine “code checkin,” which is a continuously looping asynchronous process that receives code-change requests and manages the received code-change requests up until they are submitted to the continuous-delivery/deployment functionalities of the automated application-development-and-release-management system for processing. In step 2102, the routine “code checkin” initializes the above-discussed CQ and exQ data structures as well as any additional data structures, timers, and other such computational resources needed for implementation of code-request management. Then, in step 2104, the routine “code checkin” waits for a next event to occur. When the next occurring event is the reception of a new code-change request, as determined in step 2106, the routine “new code change” is called in step 2108. When the next occurring event is expiration of a maintenance timer, as determined in step 2110, the routine “maintenance timer” is called in step 2112. When the next occurring event is an “exQ not full” event, issued when a code-change request is dequeued from exQ when it is full, as determined in step 2114, the routine “exQ available” is called in step 2116. Ellipses 2118 and 2120 indicate that additional types of events may be handled by the routine “code checkin.” When the next occurring event is a termination event, as determined in step 2122, any allocated computational resources are deallocated and other such termination tasks are performed, in step 2124, before the routine “code checkin” returns in step 2126. A default handler 2128 handles any rare and unexpected events. When another event has been queued for handling, as determined in step 2130, the next event is dequeued, in step 2132, and control returns to step 2106 for processing the dequeued event. Otherwise, control returns to step 2104, where the routine “code checkin” waits for the occurrence of a next event.

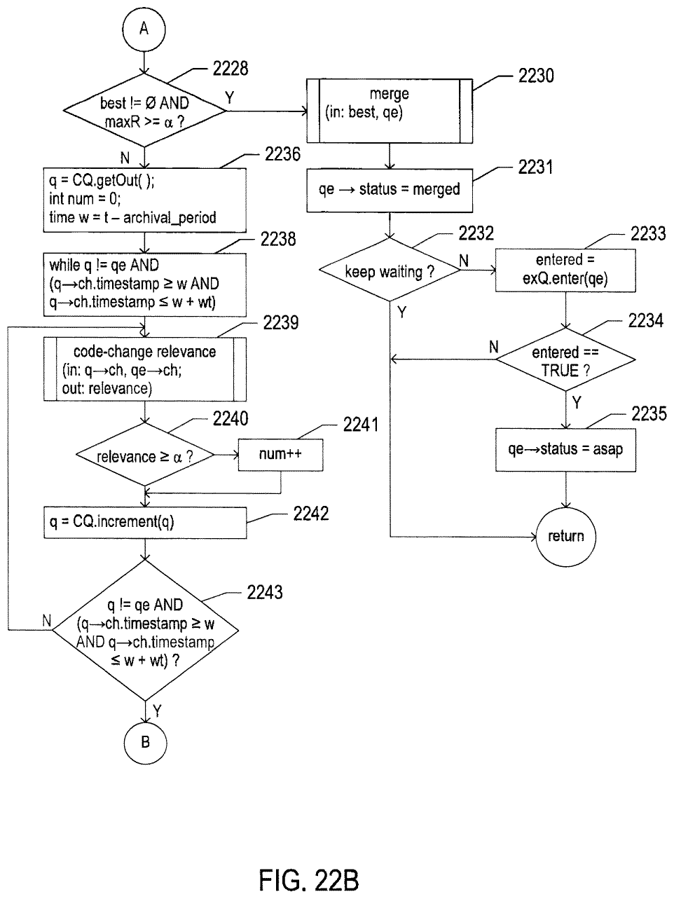

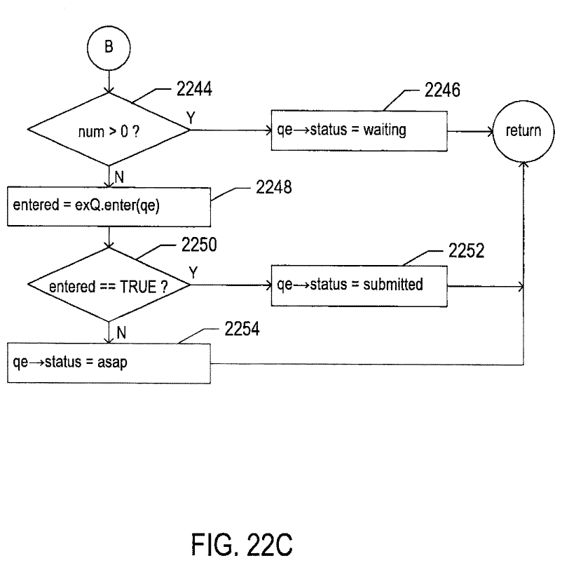

FIGS. 22A-C provide control-flow diagrams for the routine “new code change,” called in step 2108 of FIG. 21. In step 2202, the routine “new code change” receives a codeChange c and an integer flag. In step 2204, local variable t is set to the current system time, the timestamp field within the codeChange c is set to t, and a pointer to a circular-queue entry in circular queue CQ, qe, is set to reference the CQ entry into which the received codeChange c is entered by a call to a CQ method “enter.” When the received flag indicates that the received code-change request is urgent, as determined in step 2206, the status of the newly entered code-change request is set to “urgent,” in step 22. Then, in step 2210, the received code-change request is queued to the circular queue exQ, thereby submitting the received code-change request to the continuous-delivery/deployment functionalities of the automated application-development-and-release-management system for processing. When the received code-change request is successfully queued to the circular queue exQ, as determined in step 2212, the status of the CQ entry corresponding to the code-change request is changed to “submitted,” in step 2214. The routine “new code change” then returns in step 2216.

When the received code-change request is not an urgent code-change request, as determined in step 2206, then, in step 2218, a pointer q is set to point to the CQ entry referenced by the CQ waitPtr, a pointer best is initialized to a null value, and the local variable maxR is initialized to a minimum relevance value. Next, in the while-loop of steps 2220-2225, the routine “new code change” considers each CQ entry from the entry referenced by the CQ waitPtr pointer to the CQ entry queued prior to the codeChange c. In step 2221, the routine “code-change relevance” is called to determine a relevance value for the CQ entry referenced by pointer q and the codeChange c. When the relevance value returned by the routine “code-change relevance” is greater than the value stored in local variable maxR, as determined in step 2222, local variable maxR is updated to contain the returned relevance value and pointer best is updated to contain a reference to the CQ entry referenced by pointer q, in step 2223. In step 2224, pointer q is incremented via the modulo-arithmetic-based CQ method “incremented.” When the pointer best does not have a null value and the value stored in maxR is greater than or equal to a threshold value a, as determined in step 2228 in FIG. 22B, a routine “merge” is called to merge the codeChange request c with the already queued codeChange request in the CQ entry referenced by pointer best, in step 2230. The status of CQ entry storing codeChange c is then updated to contain the status “merged,” in step 2231. When the routine “new code change” determines that the merged code change referenced by qe should not remain on the CQ to wait for additional merger candidates, as determined in step 2232, then, in step 2233, the received code-change request is queued to the circular queue exQ, thereby submitting the received code-change request to the continuous-delivery/deployment functionalities of the automated application-development-and-release-management system for processing. When the received code-change request is successfully queued to the circular queue exQ, as determined in step 2234, the status of the CQ entry corresponding to the code-change request is changed to “submitted,” in step 2235, after which the routine “new code change” returns. Otherwise, when the routine “new code change” determines that the merged code change referenced by qe should remain on the CQ to wait for additional merger candidates, as determined in step 2232, the routine “new code change” returns.

The determination of whether the merged code change referenced by qe should remain on the CQ can be made, in certain implementations, by either again making a prediction based on archived code-change requests or by using a stored predicted number of likely mergers and a stored number of mergers so far carried out. In other implementations, a merged code change is always submitted for processing.

When a no candidate for merging codeChange c is found in the while-loop of steps 2220-2225, then, in step 2236, the pointer q is sent to the final, least recently queued entry in CQ, local variable num is set to 0, and a time w is sent to the current system time minus the archival period. Then, in the while-loop of steps 2238-2243, the routine “new code change” counts all of the CQ entries with timestamps greater than or equal to w and less than or equal to w+wt that have greater than a threshold relevance to codeChange c. The code-change requests considered in the while-loop of steps 2238-2243 have timestamps that fall into a range of timestamps equal to the maximum wait time extending forward in time from the current time minus the archival period. For example, when the archival period is one week, the while-loop of steps 2238-2243 determines the number of relevant code-change requests in a period of time equal to the wait time one week before the current time. This allows the routine “new code change” to predict the probability that a subsequently submitted code change within the wait time will be relevant to codeChange c and thus will be merged with codeChange c. When local variable num stores a value greater than 0, as determined in step 2244 in FIG. 22C, the status of the CQ entry containing codeChange c is updated to “waiting,” in step 2246. Otherwise, in step 2248, the routine “new code change” attempts to queue codeChange c to exQ. When codeChange c is successfully queued to exQ, as determined in step 2250, the status of the CQ entry containing codeChange c is updated to “submitted,” in step 2252. Otherwise, in step 2254, the status of the CQ entry containing codeChange c is updated to “asap,” to indicate that this code change should be queued to, as soon as possible. to exQ for processing. In certain implementations, the value stored in num, or some fraction of that value, can be used as a prediction of the likely number of possible mergers, discussed above.

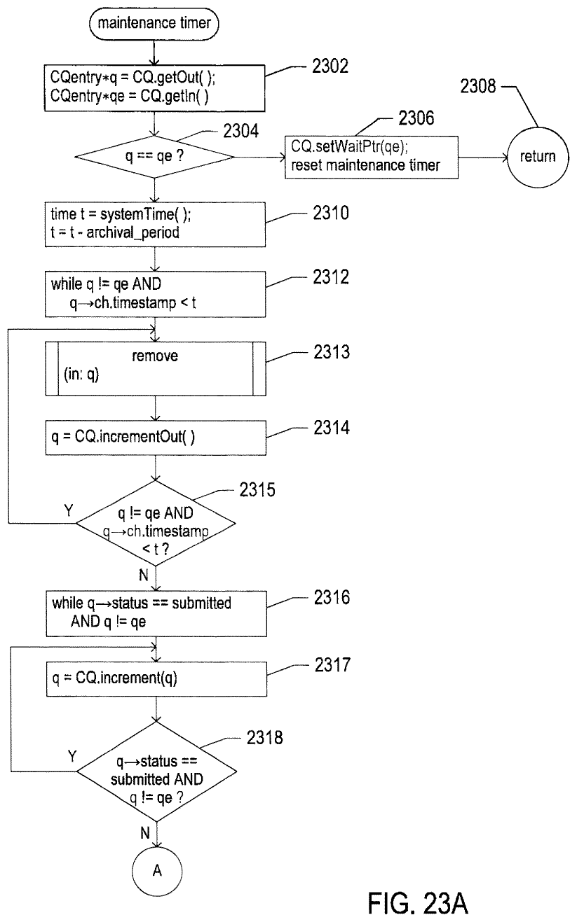

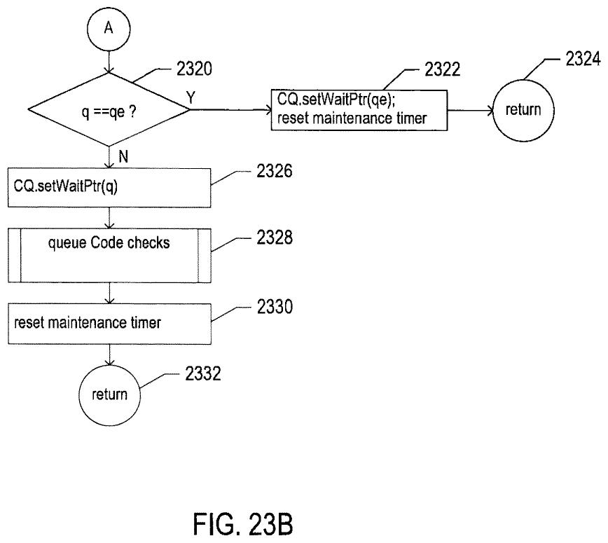

FIGS. 23A-B provide control-flow diagrams for the routine “maintenance timer,” called in step 2112 of FIG. 21. In step 2302, the routine “maintenance timer” sets pointer q to point to the first available slot or entry in CQ and sets pointer qe to point to the most recently queued entry in CQ. When CQ is empty, as determined in step 2304, the routine “maintenance timer” sets the CQ waitPtr to pointer qe and resets the maintenance timer, in step 2306, before returning in step 2308. Otherwise, in step 2310, the routine “maintenance timer” sets local variable t to the current system time minus the archival period. Then, in the while-loop of steps 2312-2315, the routine “maintenance timer” removes entries from the CQ with timestamps preceding time t so that the CQ contains no entries preceding the archival period extending backwards in time from the current time. Next, in the while-loop of steps 2316-2318, the routine “maintenance timer” advances the pointer q past all CQ entries having the status “submitted.” When q is advanced to the pointer qe, as determined in step 2320 in FIG. 23B, there are no entries in CQ currently waiting for submission, and the routine “maintenance timer” therefore sets the CQ waitPtr to qe and resets the maintenance timer, in step 2322, before returning in step 2324. Otherwise, in step 2326, the routine “maintenance timer” sets the CQ waitPtr to q. Then, the routine “maintenance timer” calls the routine “queueCodeChecks” in step 2328, to submit any waiting CQ entries for processing that are ready to be submitted and then, in step 2330, resets the maintenance timer before returning, in step 2332.

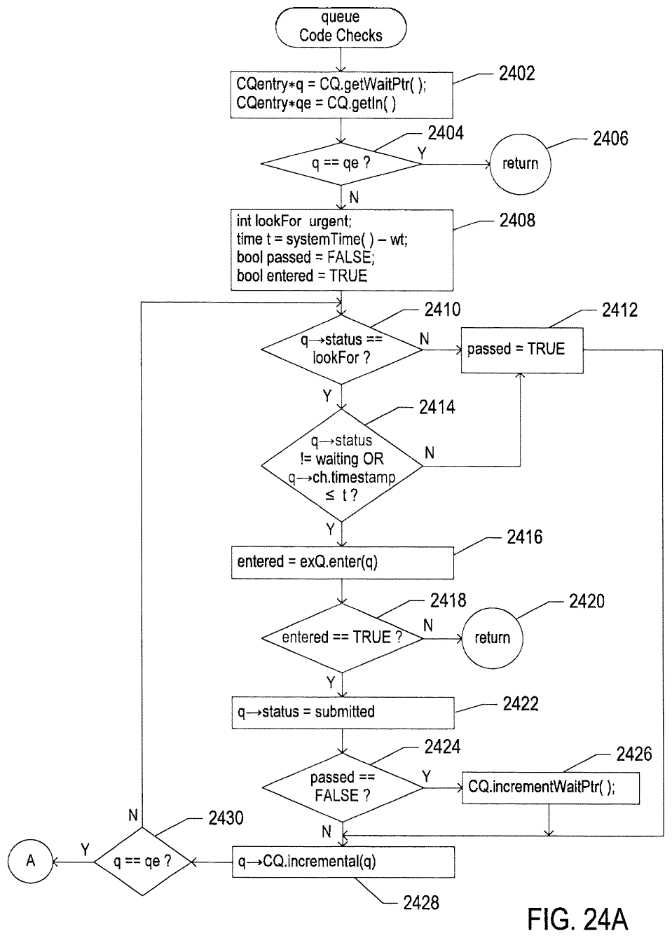

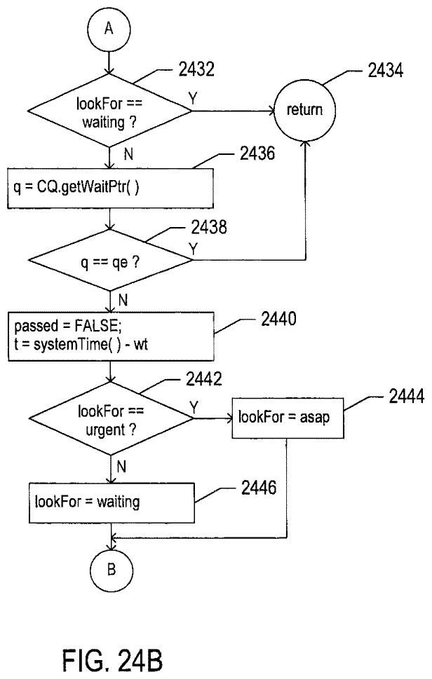

FIGS. 24A-B provide control-flow diagrams for the routine “queueCodeChecks.” called in step 2328 of FIG. 23B. In step 2402, the routine “queueCodeChecks” sets pointer q to the CQ pointer waitPtr and sets pointer qe to the CQ pointer in. When CQ is empty, as determined in step 2404, the routine “queueCodeChecks” returns in step 2406. Otherwise, in step 2408, the routine “queueCodeChecks” sets local variable lookFor to “urgent,” local variable t to the current system time minus the maximum wait-period time wt, local variable passed to FALSE, and local variable entered to TRUE. When the status field of the CQ entry referenced by pointer q is not equal to the value stored in local variable lookFor, as determined in step 2410, the routine “queueCodeChecks” sets local variable passed to TRUE, in step 2412, and advances control to step 2428, discussed below. When the status field of the CQ entry referenced by pointer q is “waiting” or the timestamp associated with the CQ entry referenced by pointer q is greater than the value stored in local variable t, then control flows to step 2412, discussed above. Otherwise, in step 2416, the routine “queucCodeChecks” attempts to queue the requested code change represented by the CQ entry referenced by pointer q to the circular queue exQ. If the code change is successfully queued to exQ, as determined in step 2418, the status of the CQ entry referenced by pointer q is changed to “submitted.” in step 2422 and, when local variable passed contains the value FALSE, as determined in step 2424, the routine “queueCodeChecks” increments the CQ pointer waitPtr, in step 2426. In step 2428, pointer q is incremented. When q is equal to the CQ pointer in, as determined in step 2430, control flows to step 2432 in FIG. 24B. Otherwise, control flows back to step 2410. When the value stored in local variable lookFor is “waiting,” as determined in step 2432, the routine “queueCodeChecks” returns, in step 2434. Otherwise, pointer q is reset to the wairPtr of the circular queue CQ, in step 2436. If q is equal to the CQ pointer in, as determined in step 4438, the routine “queueCodeChecks” returns in step 2434. Otherwise, local variable passed is set to FALSE and local variable t is set to the current system time minus the wait period wt. in step 2440. When the local variable lookFor contains the value “urgent.” as determined in step 2442, local variable lookFor is set to “asap,” in step 2444. Otherwise, local variable lookFor is set to “waiting” in step 2446. Then, control flows back to step 2410 of FIG. 24A for another iteration of the loop that begins with step 2410. In this fashion, the routine “queueCodeChecks” first tries to submit any waiting urgent requests, then tries to submit any waiting asap requests, and finally tries to submit any waiting requests that have waited for a maximum wait period.

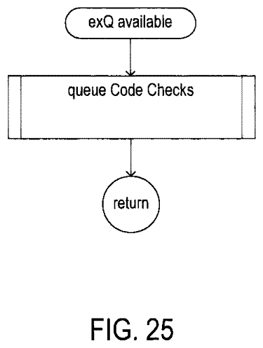

FIG. 25 provides a control-flow diagram for the routine “exQ available,” called in step 2116 of FIG. 21. This routine simply calls the routine “queueCodeChecks,” discussed above with reference to FIGS. 24A-B.

Although the present invention has been described in terms of particular embodiments, it is not intended that the invention be limited to these embodiments. Modification within the spirit of the invention will be apparent to those skilled in the art. For example, any of a variety of different implementations of the currently disclosed methods and systems can be obtained by varying any of many different design and implementation parameters, including modular organization, programming language, underlying operating system, control structures, data structures, and other such design and implementation parameters. There are many different possible specific implementations of code-change-request management functionalities used by the currently claimed subsystems to manage code-change requests for submission to continuous-delivery/deployment functionalities of the automated application-development-and-release-management system. The currently disclosed implementation uses circular queues, but a variety of different types of data structures and data-storage subsystems can be used to store code-change requests for a sufficiently long period of time to allow for predicting the probabilities of subsequently received relevant code-change requests and for periods of time during which code-change requests wait for subsequent code-change-request merger candidates. The particular criteria for deciding when to directly submit a code-change request for processing rather than delaying processing for a period of time may vary with different implementations, and is therefore parameterized, and the various times discussed above, including the archival period and maximum wait times may vary from implementation to implementation. In certain implementations, different wait times may be assigned to code-change requests based on various criteria.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A code-change-request management subsystem of an automated application-development-and-release-management system that includes continuous-integration and continuous-delivery/deployment functionalities, the code-change-request management subsystem comprising:
computational components including one or more processors, one or memories, one or more data-storage devices, and network communications; and
computer instructions stored in one or more of the one or memories and one or more of the one or more data-storage devices that, when executed by one or more of the one or more processors, control the computational components to:
receive a code-change request:
when the received code-change request is indicated to be urgent, submit the code-change request to the automated application-development-and-release-management system for testing and subsequent incorporation into an application or service;
when the received code-change request is not indicated to be urgent and when the received code-change request has more than a threshold relatedness to a waiting code-change request, merge the received code-change request with the waiting code-change request;
when a likelihood that a subsequently received code-change request having more than a threshold relatedness to the received code change will be received within a maximum wait time is greater than a threshold likelihood, delay submission of the received code-change request to the automated application-development-and-release-management system; and
otherwise, submit the code-change request to the automated application-development-and-release-management system for testing and subsequent incorporation into an application or service.

2. The code-change-request management subsystem of claim 1 wherein a code-change request includes indications of one or more source-code files for which the code-change request includes changes.

3. The code-change-request management subsystem of claim 2
wherein source-code files are processed, by a build process of the automated application-development-and-release-management system, to produce two or more levels of intermediate-executable files and a final level of target-executable files, the target-executable files used to instantiate application or service components; and
wherein target-executable files are tested and verified by a testing-and-verification process of the automated application-development-and-release-management system before they are incorporated into a distributed application or distributed service.

4. The code-change-request management subsystem of claim 3 wherein a code-change relatedness value is determined by the code-change-request management subsystem for two code-change requests by determining, for each level of a first level corresponding to source-code files, one or more additional levels of intermediate executables, and a final level of target executables, which files in the level are impacted by both code-change requests and which files in the level are impacted by only one of the code-change request.

5. The code-change-request management subsystem of claim 4 wherein the code-change relatedness value is computed as the sum of level-specific code-change relatedness values determined for each level of files.

6. The code-change-request management subsystem of claim 5 wherein a level-specific code-change relatedness value for a particular file level is determined as a ratio of the difference between a number of files in the level impacted by both code-change request and a number of files in the level impacted by only one of the code-change requests divided by the total number of files in the level impacted by one or more of the code-change requests.

7. The code-change-request management subsystem of claim 6 wherein the ratio is multiplied by a weight corresponding to the level.

8. The code-change-request management subsystem of claim 1 wherein the likelihood that a subsequently received code-change request having more than a threshold relatedness to the received code change will be received within a maximum wait time is determined by:
determining a number of code-change requests received during the maximum wait time, starting from a previous time, that have more than a threshold relatedness to the received code-change request; and
when the number of code-change requests is greater than a threshold number, determining that the likelihood that a subsequently received code-change request having more than a threshold relatedness to the received code change will be received within a maximum wait time is greater than the threshold relatedness.

9. The code-change-request management subsystem of claim 1 wherein, when the received code-change request is merged with a waiting code-change request, the waiting code-change request is submitted to the automated application-development-and-release-management system for testing and subsequent incorporation into an application or service.

10. The code-change-request management subsystem of claim 1 wherein, when the received code-change request is merged with a waiting code-change request, and when a likelihood that a subsequently received code-change request having more than a threshold relatedness to the received code change will be received within a maximum wait time, submission of the waiting code-change request to the automated application-development-and-release-management system for testing and subsequent incorporation into an application or service is further delayed.

11. A method that manages code-change requests received for submission to an automated application-development-and-release-management system that includes continuous-integration and continuous-delivery/deployment functionalities for processing, the method comprising:
receiving a code-change request;
determining whether the received code-change request should be directly submitted to the automated application-development-and-release-management system;
when the received code-change request should be directly submitted to the automated application-development-and-release-management system, submitting the received code-change request for processing by the automated application-development-and-release-management system;
determining whether the received code-change request should be merged with a code-change request waiting for submission to the automated application-development-and-release-management system;
when the received code-change request should be merged with a code-change request waiting for submission to the automated application-development-and-release-management system, merging the received code-change request with the code-change request waiting for submission to the automated application-development-and-release-management system;
determining whether submission of the received code-change request to the automated application-development-and-release-management system should be delayed to wait for subsequently received code changes that can be merged with the received code-change request;
when submission of the received code-change request to the automated application-development-and-release-management system should be delayed, storing the received code change to wait for subsequently received code changes that can be merged with the received code-change request; and
otherwise, submitting the received code-change request to the automated application-development-and-release-management system.

12. The method of claim 11 wherein the received code-change request should be directly submitted to the automated application-development-and-release-management system when the received code-change request includes an indication that the code change is urgent.

13. The method of claim 11 wherein the received code-change request should be merged with a code-change request waiting for submission to the automated application-development-and-release-management system when a relatedness value determined for the received code-change request and the code-change request waiting for submission to the automated application-development-and-release-management system is greater than a threshold relatedness value.

14. The method of claim 13 wherein the relatedness value is determined by summing relatedness values determined for each tile level of a set of file levels that include a first level corresponding to source-code files, one or more additional levels of intermediate executables, and a final level of target executables.

15. The method of claim 14 wherein a level-specific code-change relatedness value for a particular file level is determined by computing a ratio of the difference between a number of files in the level impacted by both code-change request and a number of files in the level impacted by only one of the code-change requests divided by the total number of files in the level impacted by one or more of the code-change requests.

16. The method of claim 15 wherein the ratio is multiplied by a weight corresponding to the level.

17. The method of claim 11 wherein submission of the received code-change request to the automated application-development-and-release-management system should be delayed to wait for subsequently received code changes when a likelihood that a subsequently received code-change request having more than a threshold relatedness to the received code change will be received within a maximum wait time is greater than a threshold likelihood.

18. The method of claim 11 wherein the likelihood that a subsequently received code-change request having more than a threshold relatedness to the received code change will be received within a maximum wait time is determined by:
determining the number of code-change requests received during the maximum wait time, starting from a previous time, that have more than a threshold relatedness to the received code-change request; and
when the number of code-change requests is greater than a threshold number, determining that the likelihood that a subsequently received code-change request having more than a threshold relatedness to the received code change will be received within a maximum wait time is greater than the threshold relatedness.

19. The method of claim 11 wherein, when the received code-change request is merged with a waiting code-change request:
when a likelihood that a subsequently received code-change request having more than a threshold relatedness to the received code change will be received within a maximum wait time, submission of the waiting code-change request to the automated application-development-and-release-management system for testing and subsequent incorporation into an application or service is further delayed; and
otherwise, the waiting code-change request is submitted to the automated application-development-and-release-management system for testing and subsequent incorporation into an application or service.

20. A data-storage device containing computer instructions that, when executed by one or more processors of a code-change-request management subsystem of an automated application-development-and-release-management system, control the code-change-request management subsystem to:
receiving a code-change request;
determining whether the received code-change request should be directly submitted to the automated application-development-and-release-management system;
when the received code-change request should be directly submitted to the automated application-development-and-release-management system, submitting the received code-change request for processing by the automated application-development-and-release-management system;
determining whether the received code-change request should be merged with a code-change request waiting for submission to the automated application-development-and-release-management system;
when the received code-change request should be merged with a code-change request waiting for submission to the automated application-development-and-release-management system, merging the received code-change request with the code-change request waiting for submission to the automated application-development-and-release-management system;
determining whether submission of the received code-change request to the automated application-development-and-release-management system should be delayed to wait for subsequently received code changes that can be merged with the received code-change request;
when submission of the received code-change request to the automated application-development-and-release-management system should be delayed, storing the received code change to wait for subsequently received code changes that can be merged with the received code-change request; and
otherwise, submitting the received code-change request to the automated application-development-and-release-management system.
